(19) United States
(12) Patent Application Publication
(10) Pub. No.: US 2012/0317628 A1
(43) Pub. Date: Dec. 13, 2012

(54) SYSTEMS AND METHODS FOR AUTHORIZING A TRANSACTION

(76) Inventor: C. Douglas Yeager, Austin, TX (US)

(21) Appl. No.: 13/491,922

(22) Filed: Jun. 8, 2012

Related U.S. Application Data
(60) Provisional application No. 61/685,863, filed on Mar. 26, 2012.
(60) Provisional application No. 61/573,476, filed on Sep. 6, 2011.
(60) Provisional application No. 61/575,846, filed on Aug. 30, 2011.
(60) Provisional application No. 61/520,314, filed on Jun. 9, 2011.

(51) Int. Cl. G06F 21/00

(52) U.S. Cl. 726/5

(57) ABSTRACT

Methods and apparatuses are disclosed for creating a software based secure element reader and a digital credential data delivery system for point-of-sale (POS) locations that do not have a secure element reader. Methods and apparatuses are described for creating a remotely hosted repository of secure elements that may be selected and connected to a mobile or a stationary device. Near-field communication (NFC) capabilities may be utilized to interrogate a selected secure element by a RFID POS reader through the mobile NFC device over a data connection between that mobile NFC device and the remote hosted secure element.

### CROSS REFERENCES TO RELATED APPLICATIONS

This application claims priority from and is related to U.S. Provisional Patent Application Ser. No. 61/520,314 filed Jun. 9, 2011, entitled: “Near-field Communications Payment via Wireless Network.” This application claims priority from and is related to U.S. Provisional Patent Application Ser. No. 61/575,846 filed Aug. 30, 2011, entitled: “Remote Hosted Secure Element Repository.” This application claims priority from and is related to U.S. Provisional Patent Application Ser. No. 61/573,476 filed Sep. 6, 2011, entitled: “Remote Hosted Secure Element Repository.” This application claims priority from and is related to U.S. Provisional Patent Application Ser. No. 61/685,863 filed Mar. 26, 2012, entitled: “Remote Hosted Secure Element Repository.” This application claims a priority date of Jun. 9, 2011 which is the filing date of U.S. Provisional Patent Application Ser. No. 61/520,314. Provisional Patent Application Ser. Nos. 61/520,314 and 61/575,846 and 61/573,476 and 61/685,863 are incorporated by reference in their entirety herein.

### FIELD

This disclosure relates to the field of payment and authorization methods. More particularly this disclosure relates to using a mobile computing device in combination with a remotely hosted Secure Element representation to make payments, authorizations or exchange information with other devices.

### BACKGROUND

In some payment technologies such as smartcard payment, a microchip referred to as a “Secure Element” (SE) is embedded into a payment card, a payment fob (medallion), a cell phone, or other mobile devices that may be used for making payments. For the purpose of simplifying language in this document, a device that houses the SE will be referred to as a “card” or “card device”. It is important to note that the “card” or “card device” may not physically resemble the shape or size of a typical payment card and may come in various form factors such as embedded into a mobile phone or embedded into a removable storage or removable device. Also, it is important to note that the SE may be an emulated software based SE and not strictly hardware based. For example, virtually any electronic device with a digital memory and processor or controller may be adapted to emulate and pretend to be an SE.

In order to extract information from the SE, an interrogator, also referred to in this document as a “reader,” is required to interact electrically with the SE. The reader typically follows standards set forth by the International Organization for Standardization (ISO) and the International Electrotechnical Commission (IEC) and by application providers (such as VISA and MASTERCARD).

Secure element systems typically require that the user have physical possession of a card that matches the authorization capabilities of a merchant's system where a purchase is made. In many instances this is inconvenient. Therefore more flexible and convenient systems and methods for authorizing financial transactions are needed.

### SUMMARY

In one embodiment the present disclosure provides a system for acquiring digital credential data. The system includes an electronic communication device, a communication channel, and a repository that is remote from the electronic communications device and that has a plurality of secure element representations. In this embodiment the repository is configured to receive a request for the digital credential data from the electronic communications device using the communication channel and to validate the computing device such that the electronic communication device is paired with one of the plurality of secure element representations. The repository is further configure to extract at least a portion of the digital credential data from the paired secure element representation, and to send a repository response communication with the digital credential data to the electronic communication device over the communication channel. The electronic communication device is configured to authenticate to the repository, to send a request for the acquisition of at least a portion of the digital credential data to the repository as a device command communication over the communication channel, and to receive the repository response containing the digital credential data from the repository over the communication channel.

Further provided is a method for acquiring digital credential data by a point-of-sale terminal that access to an internet from a mobile device that also has access to the internet and that also has a secure element and a secure element reader. In one embodiment, steps include reading the secure element in the mobile device using the secure element reader in the mobile device and sending the digital credential data, acquired from reading the secure element in the mobile device, from the mobile device to the point-of-sale terminal over the internet.

Also provided is a method for acquiring digital credential data by a point-of-sale terminal. In one embodiment one step include authenticating and validating a mobile device at a repository that a plurality of secure element representations, such that the mobile device is paired with one of the secure element representations in the repository. Further steps in one embodiment involves sending through a first communication channel a POS command communication from the point-of-sale terminal to the mobile device requesting the digital credential data, and sending through the first communication channel a device response communication from the mobile device to the point-of-sale terminal where the device response communication comprises at least a portion of the digital credential data.

A further system embodiment is provided for acquiring digital credential data using a mobile device. In one embodiment the system includes a point-of-sale terminal that has a NFC interface using ISO7816-4 protocol to transmit a request for the digital credential data and to receive digital credential data. This embodiment further includes a mobile device that has a NFC interface using ISO7816-4 protocol and that is configured to receive the request from the point-of-sale terminal for an acquisition of the digital credential data and to interpret the request from the point-of-sale within an operating system of the mobile device and within an application running in that operating system, and to send the digital credential data to the point-of-sale terminal using ISO8916-4 protocol generated from an application running in an operating system in the mobile device.

Also provided herein is a system for acquiring digital credential data that includes a mobile device, a first communication channel, and a point-of-sale terminal that is configured to generate a request for an acquisition of the digital credential data from the mobile device over the first communication channel and that is configured for receiving the digital credential data from the mobile device over the first communication channel. Further included in this embodiment is a repository that is remote from the point-of-sale terminal. The repository has a plurality of secure element representations and is configured to validate the mobile device and pair the mobile device with a specific secure element representation. In this embodiment the mobile device is remote from the repository and is configured to authenticate to the repository, to receive a request for the acquisition of the digital credential data from the point-of-sale terminal as a POS command communication over the first communication channel, and to send at least a portion of the digital credential data to the point-of-sale terminal as a device response communication over the first communication channel.

Further provided herein is a repository for secure element representations. The repository includes at least one secure element reader and a plurality of secure element representations that are proximate to the secure element reader. Also provides is a server that is proximate to the secure element reader. The server has a multitasking processor to communicate with the plurality of secure element representations through the secure element reader and conduct a plurality of command/response time-wise overlapping sessions with the plurality of secure element representations. The repository also has an internet connection to the server such that each of the secure element representations is addressable over the internet.

Also provided is a method for acquiring digital credential data by a point-of-sale terminal. In one embodiment a step includes authenticating and validating a stationary device at a repository that has a plurality of secure element representations, such that the stationary device is paired with one of the secure element representations in the repository. A further step in this embodiment includes sending through a first communication channel a POS command communication from the point-of-sale terminal to the stationary device requesting the digital credential data, and a further step includes sending through a second communication channel a device command communication from the stationary device to the repository.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 illustrates a command and response APDU (Application Protocol Data Unit) flow between a reader and an SE;

FIG. 2 illustrates a command and response APDU flow between a reader and an SE with specific details about the MASTERCARD PayPass application that may be installed on the SE;

FIG. 3 illustrates certain raw data related to a transaction between a reader and an SE;

FIG. 4 illustrates a format for which a reader may be required to deliver the results of a previous interrogation;

FIG. 5 illustrates a diagram of a mobile device that contains NFC capabilities;

FIG. 6 illustrates a diagram for how a mobile device that contains NFC capabilities and how that device may be used with an RFID POS reader;

FIG. 7 illustrates a diagram for delivery of relevant transactional data to a remote POS;

FIG. 8 illustrates an example QR (Quick Response) code;

FIG. 9 illustrates an example of a restaurant receipt that contains a printed QR code;

FIG. 10 illustrates an example of how a mobile device may scan and use a QR code;

FIG. 11 illustrates different ways a mobile handset that contains NFC functionality may be used;

FIG. 12 illustrates an interaction flow between a typical RFID POS reader and a mobile device with NFC or a contactless card;

FIG. 13 illustrates an interaction flow between a mobile device with NFC and a POS that does not support RFID or NFC;

FIG. 14 illustrates a repository that uses hardware representations of secure elements;

FIG. 15 illustrates a repository that uses hardware representations of secure elements;

FIG. 16 illustrates a somewhat schematic representation of a repository that uses virtual hardware representations of secure elements;

FIG. 17 illustrates a diagram of a mobile device that contains NFC capabilities and how that device may allow access to secure elements.

FIG. 18 illustrates a diagram of an addressable array of remote hosted SEs;

FIG. 19 illustrates a User ID SE address lookup table;

FIG. 20 illustrates an authorization flow for using a remote hosted SE;

FIG. 21 illustrates a data flow diagram including authorization between a mobile device and a remote hosted SE;

FIG. 22 illustrates an example of caching being used during a MASTERCARD PayPass transaction between a RFID POS and a remote SE;

FIG. 23 illustrates an example of 100% transaction caching being used during a VISA payWave transaction;

FIG. 24 illustrates an example of a transaction flow between a remote authorization server and a remote SE facilitated through a mobile handset over TCP/UDP/IP;

FIG. 25 illustrates an example of a mobile device conducting a transaction with a remote SE;

FIG. 26 illustrates an example of using a remote authorization server to deliver static T1/T2 data without the use of a Remote SE to a mobile handset;

FIG. 27 illustrates how a system may be created to simulate a remote hosted bank of SEs;

FIG. 28 illustrates how proprietary or intermingled T1/T2 data may be used over a plurality of applications specified by Application Identifier (AID) numbers; and

FIG. 29 illustrates how an operating system with individual applications may be used to simulate a SE.

FIG. 30 illustrates an embodiment of communications and communication channels between a point-of-sale terminal, an electronic communication device, and a repository.

### DETAILED DESCRIPTION

In the following detailed description of the preferred and other embodiments, reference is made to the accompanying drawings, which form a part hereof, and within which are shown by way of illustration the practice of specific embodiments of systems and methods for acquiring digital credential data and for securing authorization for a financial transaction. It is to be understood that other embodiments may be utilized, and that structural changes may be made and processes may vary in other embodiments.

A significant advantage of extracting and delivering data that are contained within an SE is provided by an ability to know beyond reasonable doubt that the data string being delivered indeed came from a particular SE or card. This knowledge creates a more secure transaction with lower risk to the merchant, card issuing bank, and card associations. Traditionally the methods for extracting information from a banking card involve swiping the magnetic stripe on a card through a magnetic stripe reader, or extracting the information with a separate contact or contactless reader connected to a point-of-sale (POS) terminal. Because of inherent security that is provided by these methods of extracting the information on the card, a merchant may receive a lower transaction fee for that particular transaction. On the other hand, reading or entering account numbers, expiration dates, and card verification codes off of a card during a phone call or internet shopping experience is less secure, and may result in a higher transaction fee. As used herein references to “point-of-sale (POS) terminals” include terminals that are installed at merchant checkout counters, automated teller machines (ATMs), self-serve facilities (such as gasoline pumps), and similar service stations where financial transactions are authorized, and also computers, servers or systems that accept payment card data for authorizing financial transactions on the internet or other TCP/IP networks. POS terminals may accept payment card data in a plurality of ways including magnetic stripe reading, NFC reading, ISO78161-3 contact card reading, manual typing of card data, accepting card data via the internet or other TCP/IP network, manual typing of card data into a website, etc.

It is important to note that acquiring transactional data from an SE (such as Track1/Track2 data located on a card magnetic stripe) is significantly different than simply using a duplicate of transactional data (such as a copy of Track1/Track2 data). A typical magnetic stripe on a card is a static data set because it never changes Track1/Track2 data between transactions or “swipes”. For this reason, the data on the stripe may simply be copied or duplicated for use without having physical access to the payment card. Simply copying the card digits printed on the front and back of the card presents this same security risk. In other words, the data on a magnetic stripe may be copied and even programmed to another mobile device and used to make transactions continuously from the copy with no technical limitation. In the same way, card numbers that are simply copied from the face or front or back of the card and programmed to a mobile device and may also be continuously used to make transactions without a technical limitation.

In contrast to the acquisition of transactional Track1/Track2 data from a magnetic stripe on a card, the acquisition of transactional Track1/Track2 data from a SE is “singular.” In other words, those data have a life span of a single transaction or a single “swipe” and then the data are no longer valid. Moreover the Track1/Track2 data acquired during an SE interrogation cannot be created by any other entity except the SE which has been programmed with secret keys owned by the bank that loaded the keys and their accessing system to that SE.

Knowing this difference, various embodiments disclosed herein are directed specifically to SE transactions because the security of these types of transactions makes the architecture much more credible and secure under current industry banking and processing standards.

Cards containing an SE are typically presented to an RFID (Radio Frequency Identification) reader device as the interrogator that extracts the information from the card and delivers the data to the POS terminal and then forwarded by the POS terminal on to a card processor for authorization. Mobile phones that contain NFC (Near Field Communication) functionality with embedded SEs have the ability to pretend to be (or emulate) a card that contains an SE. In this case the mobile phone may be presented to the RFID reader just as a card would be presented, and the information may be extracted from the SE that is on the mobile phone and delivered to POS, which then forwards the data on to a card processor for authorization.

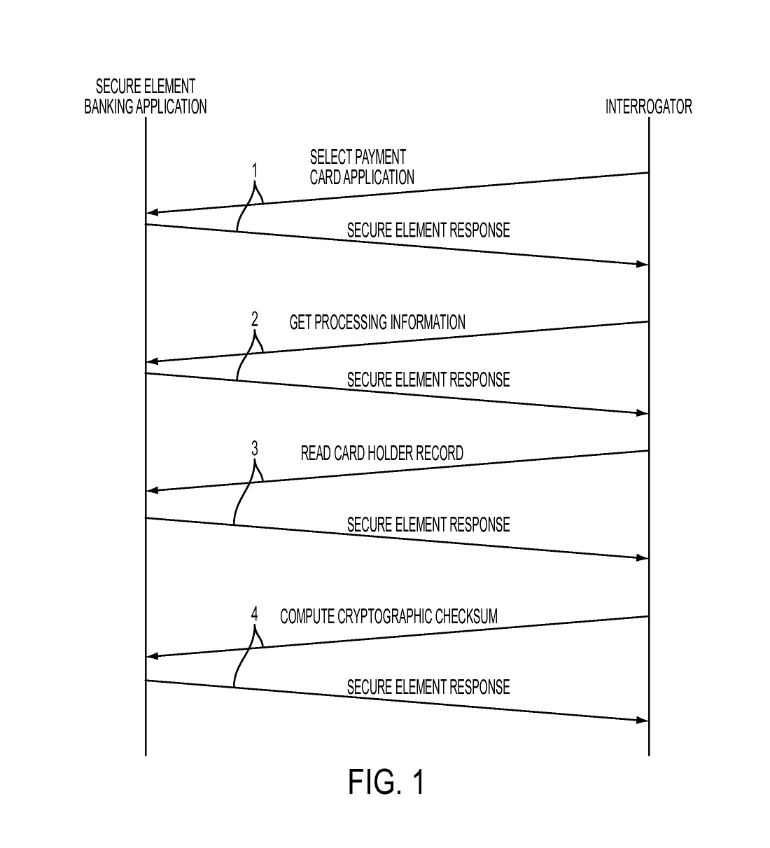

FIG. 1 describes a protocol level communication between a reader and an SE. The protocol layer is a standard protocol referred to as APDU. APDU stands for Application Protocol Data Unit and typically the protocol is defined by ISO/IEC specification 7816. This specification (commonly referred to as “ISO 7816” is a broad specification with different sections directed toward different “layers” of communication protocols, as seen in Table 1.

TABLE 1

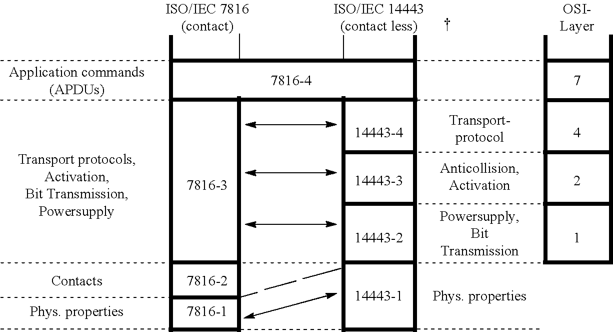

Communications referred to herein as being according to ISO7816-4 correspond to Open Systems Interconnection (OSI) layer 7. The OSI model is a product of the Open Systems Interconnection effort at the ISO. OSI layer 7 is a high-level software applications layer. The APDU section of the 7816-4 specification describes two forms of APDU communications abbreviated as C-APDU (“command APDU”) and R-APDU (“response APDU”). “Commands” are sometimes referred to as “queries” because they originate from an “interrogator,” which has a querying connotation.

The APDU data typically are transmitted over the air on 13.56 MHz radio waves between the reader and the SE. There is no hardware requirement limitation on this process; the APDU commands are just data moving from one entity to another. Various embodiments disclosed herein use the standard APDU commands to interact with the SE regardless of whether the SE is the mobile device's own embedded SE, or is a remote SE embedded into a different mobile device or a card. Communications 1, 2, 3 and 4 show the sequential commands of a typical command and response between and SE and a reader. Usually multiple steps are involved with accessing a SE, which involves multiple APDU commands and responses. FIG. 1 shows the general interrogation steps to access digital credential data specifically for a MASTERCARD PayPass Mag Stripe application running on an SE, according to “Mag Stripe.pdf” (Ver. 3.3) presently available at http://www.PayPass.com/approved-products.html. In general, the term “digital credential data” as used herein refers to at least a portion of all data that are necessary to authorize approval of a transaction at a POS terminal.

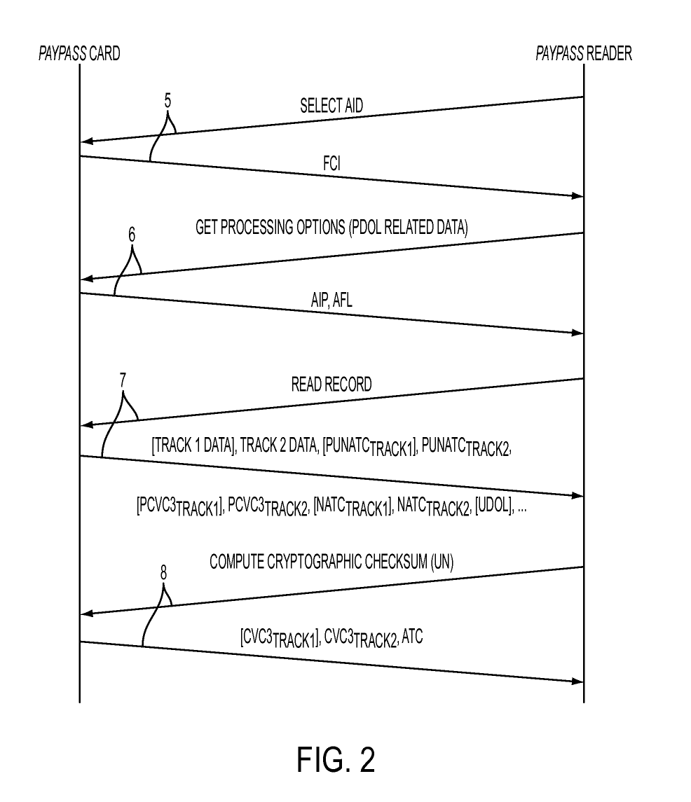

FIG. 2 describes the detailed commands and responses expected when a reader interrogates a MASTERCARD PayPass Mag Stripe Ver. 3.3 application running on a SE. This sequence is provided in the MASTERCARD PayPass specification. Shown in FIG. 2 are communications 5, 6, 7, 8 and 9 with details including abbreviations and acronyms explained subsequently herein.

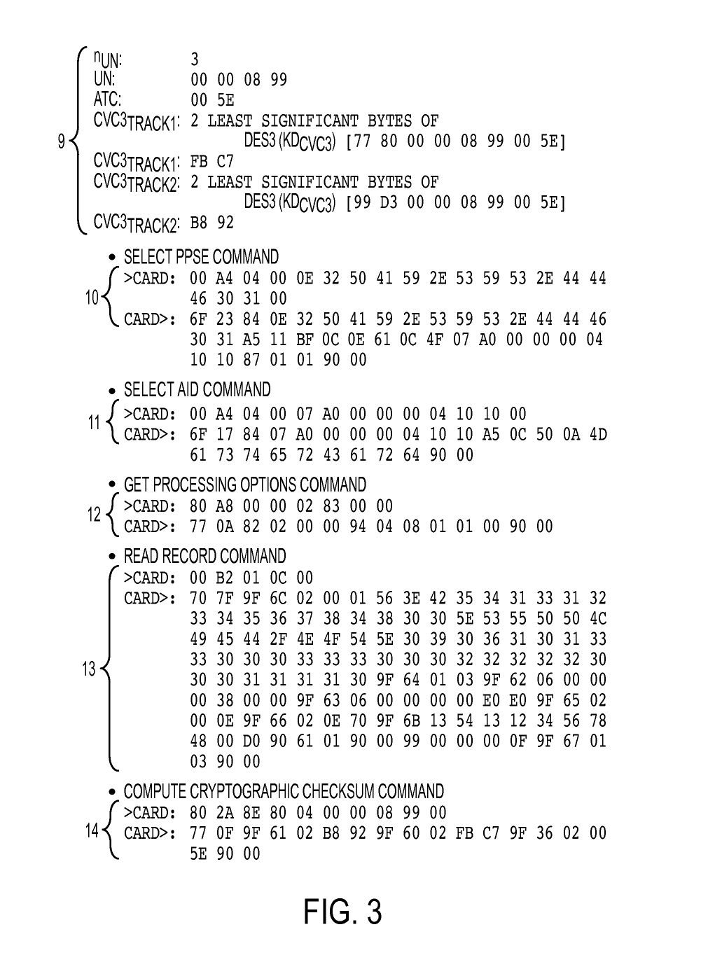

FIG. 3 describes example transactions at the ISO/IEC 7816-4 Application Protocol Data Unit (APDU) protocol level between a reader and a card. The transaction processing depicted in FIG. 3 is representative of the MASTERCARD PayPass Mag Stripe application specification v. 3.3. The notation “>CARD” denotes commands to the card and the notation “CARD>” denotes responses from the card. Communication 9 defines some of the initial parameters used in the transaction which include an unpredictable number issued by the reader, a transaction counter maintained on the SE. Communication 10 describes the command that the reader issues to the SE to find out what applications exist on the SE. This example shows that the MASTERCARD PayPass application responds as an active one. Next, communication 11 shows how the reader commands the SE to properly select the PayPass application for further processing. Communication 12 shows how the reader receives the type of processing options that the PayPass application supports. Communication 13 shows how the reader commands and then receives the PayPass application specific credential information about its card holder including card account number, holder name, expiration date, and more. Communication 14 shows how the reader receives the dynamic aspects of the transaction that will be inserted into the Track 1 and Track 2 data. This command uses a shared key on the SE, the unpredictable number from the reader, and the transaction counter on the SE to determine a new number sequence for each transaction. After the SE calculates the number, it sends it back to the reader in the response APDU. These data are obtained through the MASTERCARD PayPass specification that was referenced earlier in this document. All details including abbreviations and acronyms are explained in detail through that specification document.

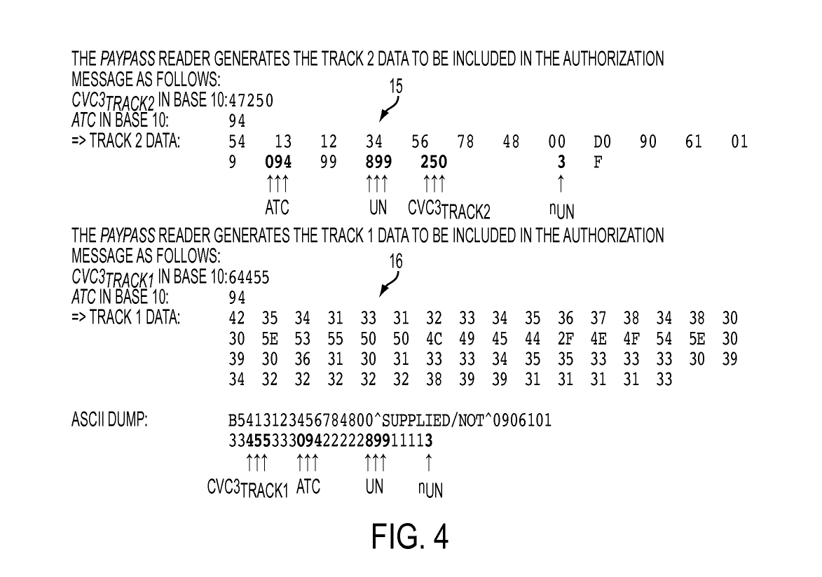

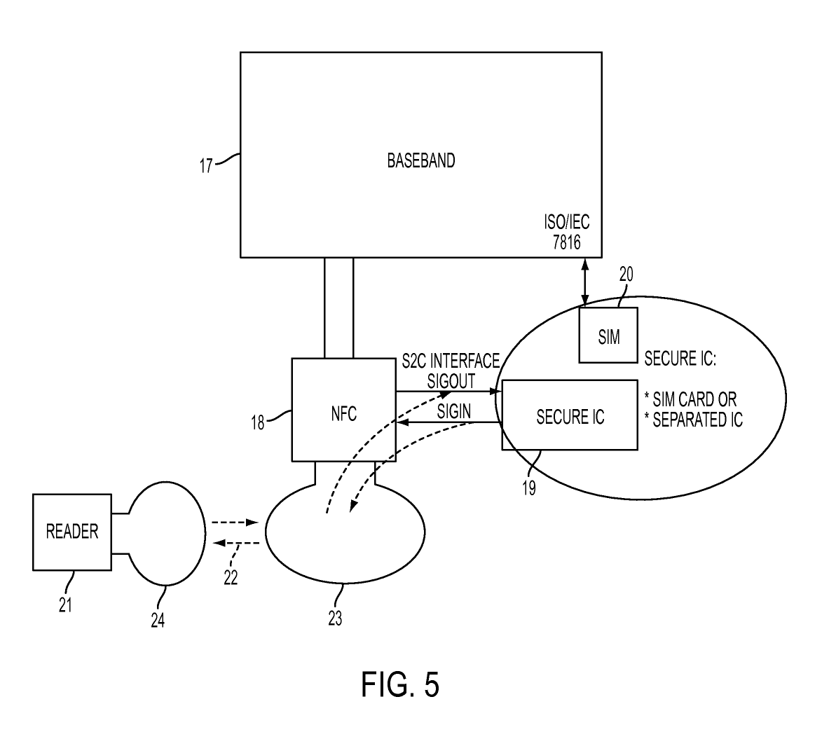

FIG. 4 describes how the reader 21 in FIG. 5 formats the response data received from the SE into accepted Track1 and Track2 data strings that are used in existing processing systems. Communication 15 shows a Track2 data string built from the card interrogation in FIG. 3. The CVC3(Track2) UN and ATC numbers will all vary with each transaction or interrogation of the SE. Communication 16 shows a Track1 data string built from the card interrogation in FIG. 3. CVC3(Track1), ATC, and UN numbers will all vary with each transaction or interrogation of the SE. These data are obtained through the MASTERCARD PayPass specification that was referenced earlier herein. All details including abbreviations and acronyms are explained in detail through the cited MASTERCARD specification document.

FIG. 5 describes the inner architecture of a mobile device that supports NFC functionality. Examples of such devices are described in U.S. Pat. No. 8,151,345 issued to C. Douglas Yeager from U.S. patent application Ser. No. 12/019,318. U.S. Pat. No. 8,151,345 and U.S. patent application Ser. No. 12/019,318 are incorporated by reference in their entirety herein. A base band processor 17 of a mobile device typically runs an OS (Operating System) to control all aspects and interfaces on the device including communication access to the SIM, NFC controller, Secure IC 19. The NFC controller acts as a router to determine where the communication is routed. The baseband controller has the option:
a. To communicate through the NFC controller to the reader and antenna 23 to communicate with an external card or device 24 over 13.56 MHz radio 22. There are 2 modes of this:
   i. The external card or device is a passive tag. This is reader mode
   ii. The external card or device is a mobile device in peer to peer mode.
b. To communicate through the NFC controller to the embedded Secure IC
c. To configure the NFC controller into card emulation mode in which case the NFC controller routes information from the external antenna 23 directly to the Secure IC 19 or a SIM 20.
   Both options a. and b. could use APDU data to exchange information between the baseband processor 17 and the applications located in the internal SE 19 or to a remote SE. It is important to note that the SIM 20 or Secure IC (SE 19) may also be created with software and emulated within the baseband processor 17. The interrogation example mapped out in FIGS. 3 and 4 could easily be implemented on this system in all three modes a., b., and c. above. This suggests that the baseband processor 17 could perform the identical interrogation on the internal secure element 19.

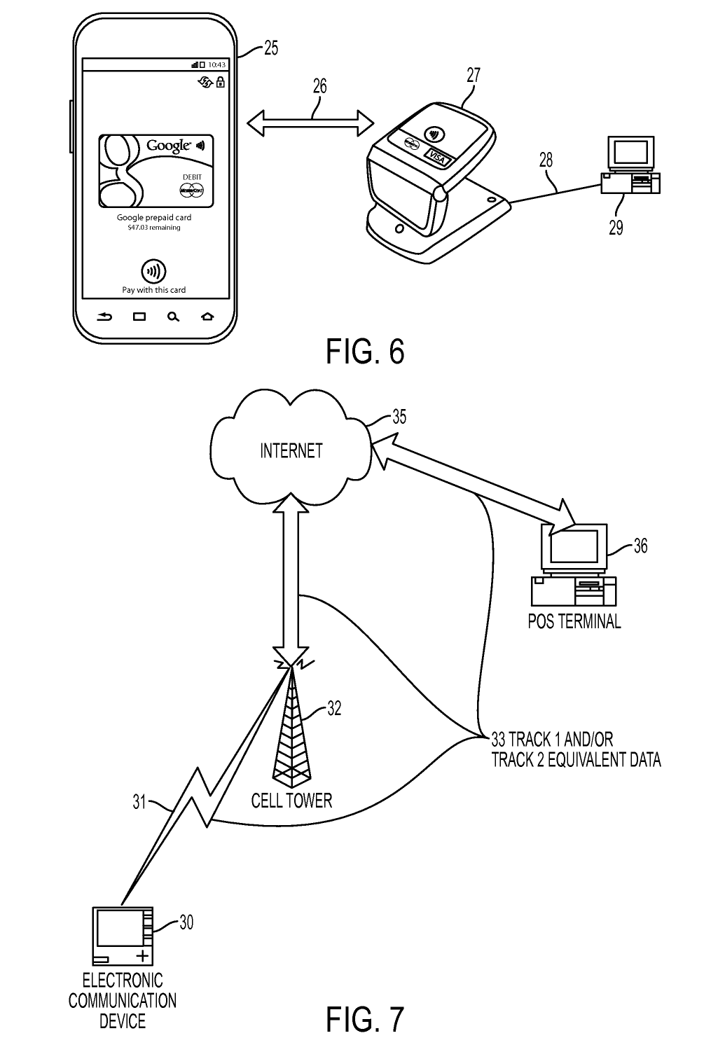

FIG. 6 describes a typical interaction between a mobile device with NFC functionality and an RFID POS reader. The mobile device 25 is set to NFC mode in which it is emulating or pretending to be a card. The mobile device 25 is then presented to the RFID reader 27 and communication begins over the 13.56 MHz baseband 26. The reader then interrogates the card similar to FIG. 1 and FIG. 2, and FIG. 3 and compiles the standardized credential data into Track 1 and Track2 equivalent data like in FIG. 4. The term “equivalent” is used in some industry documentation to refer to Track1/Track2 data that were not generated by a magnetic-head reader from a magnetic stripe on a card, but instead are created in a purely digital data form, such as by an RFID reader. The term “Track Data” is used herein to refer to data comprising all or portions of the Track 1 and/or Track 2 data as defined in ISO7813. The data are then delivered to the connected POS computer 29 that then routes the data properly to the processor with other transactional information for authorization. In some embodiments Track Data are delivered to a field in a transaction authorization system using keyboard emulation. Some software applications expect data to be entered using a keyboard, and the application may check features of the data entry process, such as cadence and elapsed time, to verify that the data are entered via a keyboard. “Keyboard emulation” refers to a process of delivering data by a device or software representation of a device that is not a physical keyboard in manner that tricks the operating system into believing that a key has been pressed. Effectively the keyboard emulation system provides an entry as if it were a keystroke in a form field that correctly has the focus of the cursor.

FIG. 7 describes the interaction that accomplishes the same task according to various embodiments disclosed herein where a POS computer does not have an RFID reader (or other reader) attached to it, but does have access for data to be received over a data connection to the internet or other global network. The scenario illustrated an electronic communication device 30 that has the ability to access a secure element with a credential that may be used for card transaction processing. The device 30 may be a mobile device or a stationary device. As used herein the term “mobile device” refers to an electronic communication device having a weight of less than 2 pounds (0.907 kg). Examples of mobile devices are cell phones, smart phones, personal digital assistants (PDAs), electronic book readers and tablet computers, provided that the device weighs less than 2 pounds (0.907 kg). The term “stationary device” as used herein refers to an electronic communication device having a weight of 2 pounds (0.907 kg) or greater. Examples of stationary devices are desktop computers, internet-ready television sets, and video game players, provided that the device weighs 2 pounds (0.907 kg) or more. A laptop computer having electronic communication capability is considered to be a mobile device if it weighs less than 2 pounds (0.907 kg) and is considered to be a stationary device if it weighs 2 pounds (0.907 kg) or more.

In the scenario of FIG. 7 the POS computer has no RFID, card reader or other interface to receive the credential in the right format (e.g., Track1/Track2 equivalent data). For this scenario, the device 30 has the ability to act as its own reader and interrogate the SE just as an external RFID reader would to gather the appropriate credential data and format the data to the Track1/Track2 equivalent format.

The device 30 also has the ability to deliver this new information over its data connection 31 to the internet 35. In cases where the device 30 is a mobile device such as smart phone, communication with the internet 35 may be through a cellular network tower 32. In cases where the device 30 is a stationary device the connection from the device 30 to the internet 35 may not use a connection through a cellular network and in such cases the cellular network tower 32 would not be employed. The internet 35 may then route the data to the appropriate POS terminal 36 for processing in its normal method to the remote processor for card and transaction authorization. It may be imperative for the device 30 to also collect some information about the transaction or location prior to sending the Track1 and Track2 data over the data connection. This information may consist of:
a. Identifier of the POS terminal 36 that should ultimately receive the information
b. The amount of the transaction, or other details about the transaction such as:
   i. Table number or ID for a restaurant
   ii. Order identifier
   iii. The UN (Unpredictable number) that is used in the transaction calculation described in FIG. 1 (4), FIG. 2 (8), FIG. 3 (9) and (14), and FIG. 4 (15) and (16)

Note that in the embodiment of FIG. 7, it is not necessary that the device 30 be physically near the POS terminal 36. That is, the device 30 may be remote from the POS terminal 36. In such circumstances information regarding the POS terminal 36 that should received the information may be manually input to the device 30 or selected from a list or search a list of locations for the specific transaction. However, if the device 30 is physically near the POS terminal 36, such as might be the case if the device 30 is a mobile device) then the information to identify the POS terminal 36 that should ultimately receive the information may be gathered by the device 30 using a number of additional ways including:
a. Using the QR code scanner in the mobile device to read a QR code that has a link to or contains all or part of this information
b. Using the RFID reader in the mobile device to read a passive RFID tag that has a link to or contains all or part of this information
c. Using the geo-location GPS sensors in the mobile device to understand the current location of the mobile device and pare down a list of POS devices (or even identify a specify POS) that is to be the receiver of the information.
d. Using all or part of the methods above.

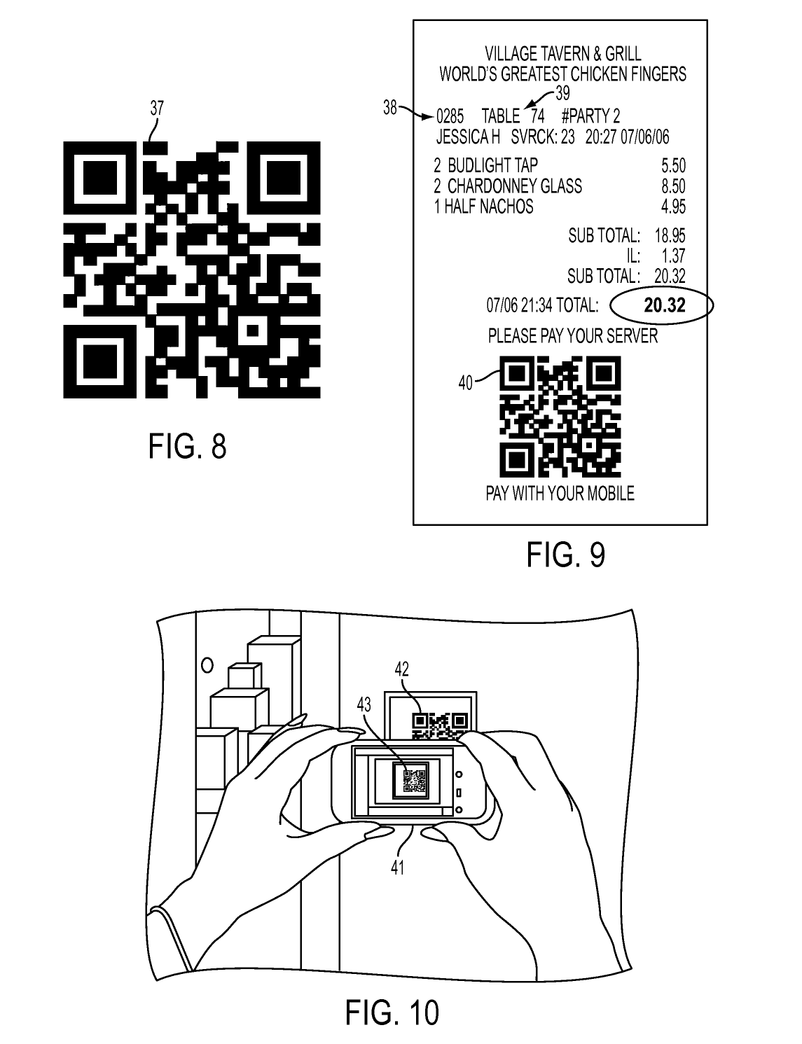

FIG. 8 describes an example of a QR (Quick Response) code. The code 37 may easily be generated or printed on stickers, paper, receipts, tabs, or invoices. The code 37 is a standardization that may be read with built in scanners or readers on many mobile devices. The code itself may contain raw data or a URL (Universal Resource Locator) that may direct a browser to a certain specific web portal and also deliver information to that portal. The code 37 is usually scanned using the mobile devices on board camera and software that may decode the code 37 and automatically launch and take action on it.

FIG. 9 describes one application and use case for a QR code. In this case the code is printed at the bottom of a receipt that a waiter would bring a customer at the end of a meal. The code 40 could contain information about the order such as order number 38 or table number 39 as well as total transaction amount and other items from the bill. If the code is scanned and the mobile device launches a browser to a location that may describe the same bill and possibly prompt for additional information such as service gratuity or tip amount.

FIG. 10 describes a general method by which a QR code may be used with a mobile device. A physical QR code 42 is printed on a sign or paper and a mobile device 41 is used to scan or read the code 42 with the mobile device camera function. The code 42 may be a unique identifier for a POS terminal, providing specific identification of the POS terminal for conducting a transaction. That POS terminal is then referred to as an “identified point-of-sale terminal” for that transaction. The code 42 may provide a unique network (e.g., internet) address for the identified point-of-sale terminal. The code 42 may identify the POS terminal as having an RFID reader, and as such the code 42 is an example of an RFID tag code. FIG. 10 shows how the mobile device 41 views and scans the code on the wall through its view finder 43, a process referred to as “reading a QR code.” In some embodiments the mobile device 41 may have a global positioning system (GPS) geo-location utility that provides information about the geographic coordinates of the POS terminal, and that information may be used in whole or part to provide the specific identification of the POS terminal.

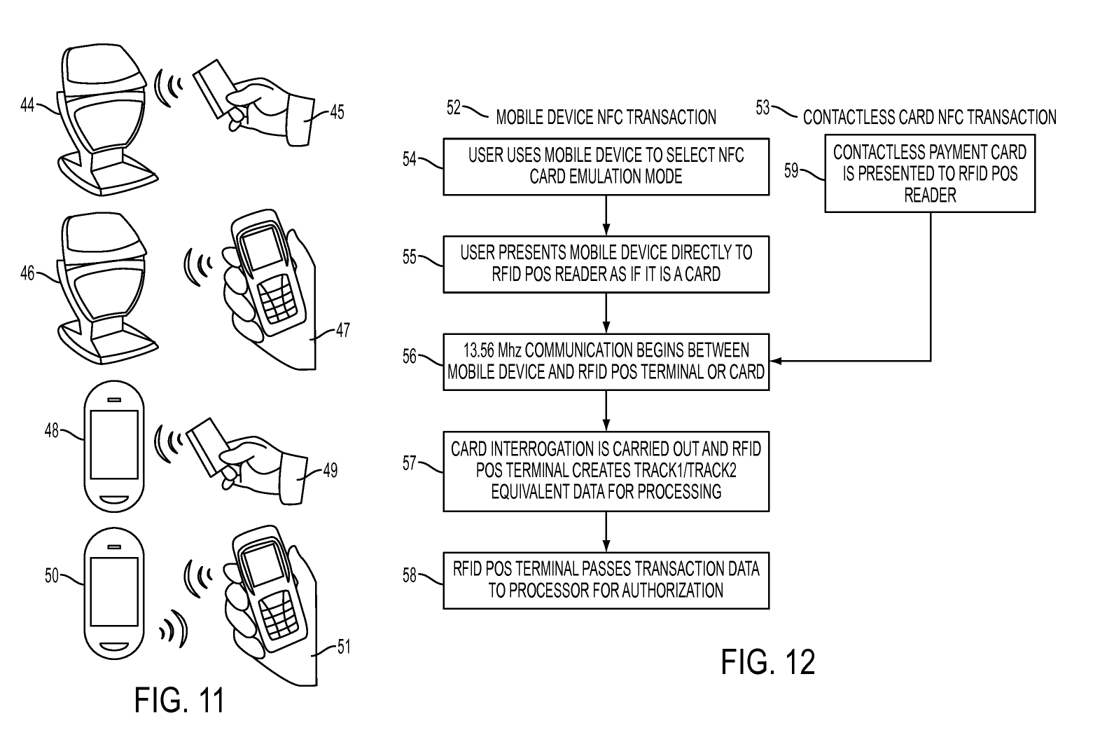

FIG. 11 describes various ways that point-of-sale RFID readers and NFC mobile devices and contactless cards may be used through various modes. An RFID reader 44 and an RFID card 45 are depicted to show how a contactless card (e.g., RFID card 45) is presented to the RFID reader 46 to carry out interrogation of that card over a near-field communication channel. The RFID reader 46 and the mobile device 47 are depicted to show how the NFC enabled mobile device 47 is presented to the RFID reader 46 (which may be the same as RFID reader 44) to carry out interrogation of that device. An NFC-enabled mobile device 48 and an RFID card 49 (which may be the same as RFID card 45) are depicted show how the contactless card 49 may be presented to the NFC enabled mobile device 38 for interrogation of that card. An NFC-enabled mobile device 50 (which may be the same as NFC-enabled mobile device 48) and a second NFC-enabled mobile device 51 (which may be the same as NFC-enabled mobile device 47) are depicted to show how the second NFC enabled mobile device 51 may be presented to the NFC-enabled mobile device 50 for interrogation of that separate second mobile device 51.

FIG. 12 describes a typical transaction flow between an NFC enabled mobile device 52 or a contactless card 53. Step 54 describes setting up the mobile device to perform a transaction with an RFID POS reader. Step 55 describes presenting the mobile device within field range of the RFID POS reader. Step 59 describes presenting a contactless payment card to an RFID POS reader. Step 56 describes the RFID POS reader interrogating either the mobile device or the contactless card over the 13.56 MHz radio. Step 57 describes how the RFID POS reader constructs the Track1/Track2 data from the interrogation. Step 58 describes how the formatted data are delivered to the POS and on to the processor for authorization.

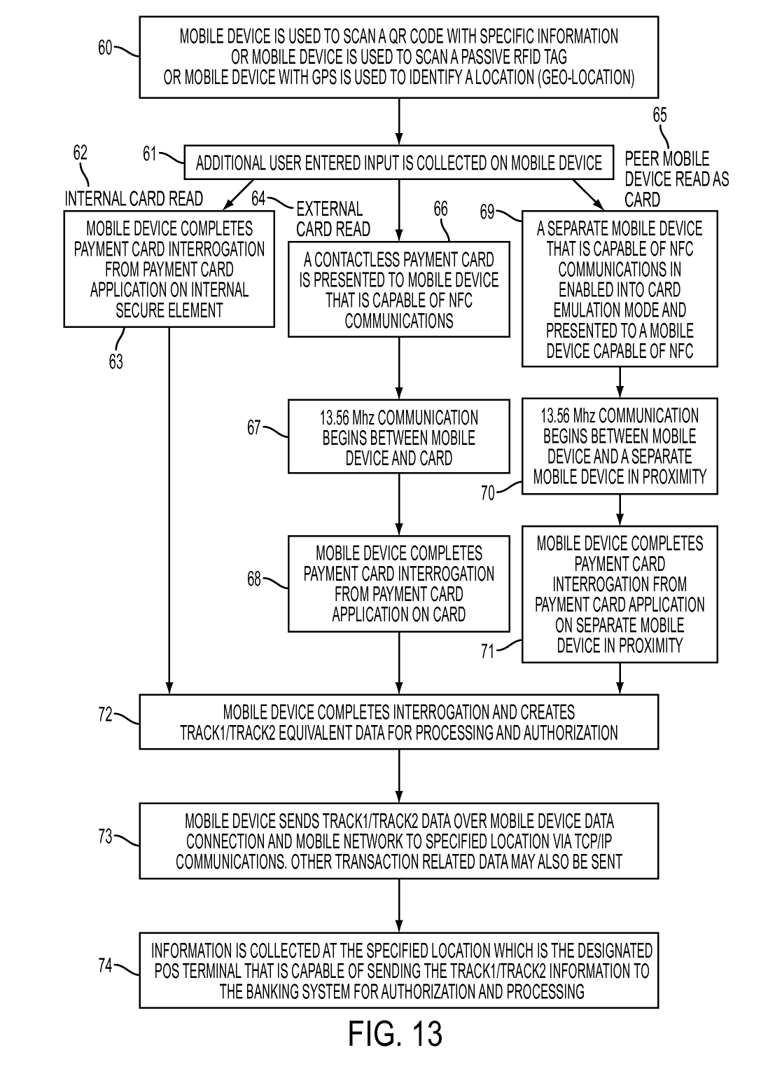

FIG. 13 shows an exemplary embodiment where the flow of an NFC mobile transaction with a POS system does not involve an RFID reader to accept the card transactional data for processing. Step 60 describes how the operator of the mobile handset may begin the payment transaction by:
a. Using the mobile device to scan a QR code that contains specific information about the transaction or POS location and may include specific transactional data like order ID or table ID.
b. Using the mobile device to scan a passive RFID tag with an on-board RFID reader on the mobile handset. The tag may contain the same information as a. above.
c. Using the mobile device geo-location or GPS service to identify the location of the device and deduce the likely POS location information from its location.

More information may also be acquired automatically from the mobile device automatically in step 60 such as
a. GPS geo-location coordinates that identify the location of the mobile device
b. A universal timestamp from the device or a remote system

This information may be used for security and validation measures to protect against invalid duplicate transactions and remote transactions.

Step 61 describes how additional input may be collected from the operator of the mobile device about this transaction. This information that may be collected may contain and is not limited to:
a. Location information of a specific POS, merchant, etc.
b. Transaction information such as gratuity amount, total amount, table ID, tab ID, Order ID
c. Specific data that is used when calculating the dynamic aspects of the transactional Track 1/Track2 data by the reader such as the UN (Unpredictable Number) shown in FIG. 1 (4), FIG. 2 (8), FIG. 3 (9) and (14), and FIG. 4 (15) and (16)
d. Opinion or review information about an experience that may be tied to personal social publishing portals, or other review or opinion portals. An example is: “leave a review for Bruno's Pizza”
e. Offer and deal presentation about the transaction such as: “save 5% and publish your location and merchant specials to your facebook wall now!”

Three configurations (internal card read 62, external card read 64 and peer mobile device read as card 65) are depicted to describe how payment card data may be obtained through a mobile device. The operator may have the choice to use the mobile device to interrogate a SE from a contactless payment card from his own pocket or wallet over the mobile device's RFID interface (i.e., the external card read 64 configuration). The operator may also have the ability to interrogate a SE on a separate mobile device through its RFID interface (i.e., the peer mobile device read as a card 65 configuration). The operator may also have the ability to interrogate the SE element that is embedded in its own hardware (i.e., the internal card read 62 configuration).

For an internal card read 62 configuration, step 63 describes how it may complete the interrogation of the payment card application on the internal SE.

For an external card read 64 configuration, step 66 describes how a contactless payment card may be presented to the mobile device. This interrogation is also shown in FIG. 11 using the NFC-enabled mobile device 48 and the RFID card 49. Step 67 describes how communication over the RFID radio between the mobile device and the contactless card SE is carried out. Step 68 describes how interrogation is completed between the mobile device as the reader and the contactless card.

For a separate peer mobile device read as a card 65 configuration, step 69 describes how a separate peer NFC enabled mobile device is presented to the mobile device that is controlled by the operator and is acting like a reader. This interrogation is also shown in FIG. 11 with the NFC-enabled mobile device 50 and the second NFC-enabled mobile device 51. The NFC-enabled mobile device 50 is controlled by the operator who is completing the transaction with the merchant. The second NFC-enabled mobile device 51 is in card emulation mode and has a secure element that represents the payment card with which the transaction is being completed. This may be applied, for example, if a user's friend is paying for the tab. Step 70 describes the communication over the RFID radio between the mobile devices. Step 71 describes how interrogation is completed between the NFC-enabled mobile device 50 that is used as the reader and the other second NFC-enabled mobile device 51 that is used as the card.

Step 72 describes how the mobile device (i.e., configuration 62, 64, or 65) compiles and formats the data achieved during interrogation into standard Track1/Track2 data that is widely accepted by POS processing computers. An example of the interrogation and Track1/Track2 data formatting that is accomplished by the mobile handset is illustrated in FIG. 1, FIG. 2, FIG. 3, and FIG. 4.

Step 73 describes how the relevant Track1/Track2 data are sent in a data message to the appropriate location over a TCP/IP communication data stream. The data message is routed over TCP/IP to a designated address of the proper POS terminal. Other data about the transaction may also be contained in the data message. The data that were obtained in steps 60 and 61 are used to identify the proper location or TCP/IP address of the proper POS terminal for further processing. GPS coordinates of the mobile device that may be automatically acquired during 60 may be used for security and validation that the mobile device is physically located at the merchant. 73 may use these GPS coordinates as a security validation measure. Timestamps of the start of the scan or transaction that are acquired in step 60 may also be used as a security validation measure.

Step 74 describes how the information may be received by the designated POS terminal. The POS terminal may have some TCP/IP listening server software installed on it to receive these designated data messages described in step 73. The POS terminal may then process the received data message in a number of different ways that include:
a. Keyboard emulation which essentially acts exactly like a USB magnetic stripe swipe terminal that literally pretends to be a keyboard and type the Track1/Track2 data into an open field on the POS terminal software for processing.
b. Interfacing embedded software that receives Track1/Track2 data from a connected swipe terminal and compiles Track1/Track2 data with the additional transactional data to be delivered for processing.

The systems and methods described herein above may be extended to facilitate transactions at a point-of-sale terminal where it is not necessary for the user (e.g., the purchaser) to have physical possession of a card with a magnetic stripe or possession of a secure element at the point-of-sale terminal. Such systems typically employ a “Remote Hosted Secure Element” (RHSE). An RHSE is a repository for a plurality of “secure element representations” each of which is provided for one or more mobile devices or mobile device owners. The repository storing the plurality of secure element representations is typically remote from the point-of-sale terminal. As used herein the term “remote” refers to locations that are geographically far apart. One indication of remoteness is that the two locations are not within a distances such that most persons at one or the other of the remote locations would consider walking to the other location, or at least would not be able to do so within one day. This frame of reference is provided merely to explain the meaning of the term “remote” and does not imply that actually walking between remote locations has anything to do with embodiments disclosed herein. To further explain remoteness using as an example the situation where many point-of-sale terminals are serviced by one repository, it is entirely possible that one or more of the point-of-sale terminals may be within walking distance of the repository. However, when that is not the case for most of the point-of-sale terminals having access to the repository, then all of these point-of-sale terminals are considered to be remote from the repository.

The plurality of secure element representations (or the “array of secure element representations”) is typically hosted in a secure environment such that it is protected from cyber attack. The secure element representations may be (a) actual SE hardware (referred to herein as a “hardware representation”), or may be (b) virtual hardware secure element representations such as a computer model that simulates the operation of a hardware SE element (referred to herein as a “virtual hardware secure element representation”), or may be (c) data in a database (typically a secure database), such as static Track Data or data dynamically or statically generated by an HSM (Hardware Security Module), where the data in the database are elements of data that are typically stored in an SE memory (referred to herein as a “database secure element representation”). The term “software representation” is used herein to refer to either (i) a virtual hardware secure element representation or to (ii) a database secure element representation. As the terms are used herein, a “secure element,” a “remote secure element,” an “SE,” or a “remote SE” may be a hardware representation, or a virtual hardware secure element representation, or a database secure element representation. A specific form of representation, or a combination of just two of these three forms of representation, may be advantageously employed in certain embodiments such as described in the context of various figures and descriptions provided herein.

In a case where an array of secure element representations are present as actual SE hardware, a repository may be created with a network server that is connected to a wide-area network (such as the internet) and one or more SE readers that are each addressable by the network server. The one or more SE readers receive ISO 7816 protocol commands for communication to an SE using a communications protocol such as TCP/UDP/IP data packets. The one or more SE readers are each in communication with one or more SE's. Software and hardware that interacts with each card reader has the ability to query (command) each SE at a particular network address that corresponds to a particular remote mobile device. As a result data that are to be passed to a particular SE from a remote mobile device are translated (if necessary) and routed over a TCP/UDP/IP network to the correct hardware SE reader and hence to the SE. Responses from the SE are relayed to that particular remote mobile device. These readers and SEs are not limited to one particular form factor or any particular communications protocol.

In a case where an array of secure element representations are present as virtual hardware secure element representations, the one or more SE readers may interact with the virtual hardware secure element representations in substantially the same manner as the one or more SE readers interact with hardware representations (i.e., actual SE hardware). A software representation allows a completely contained system that gives the same remote mobile device functionality as the previous completely hardware based case. An example of a virtual hardware secure element representation is the jcop.exe software that is presently sold and supplied by NXP semiconductor within the JCOP tools suite. The jcop.exe software provided is not a secure element, but rather a self-contained smart card operating system contained within an executable file that is meant to run on a host computer as a process. When jcop.exe runs, it opens a communications port that is accessible through the host computer operating system. The communications port that jcop.exe opens up accepts and responds to 7816-4 protocol and effectively simulates real SE hardware. The JCOP tools suite that contains jcop.exe additionally is a development platform to develop Java Card applications. JCOP tools give the user the ability to program and test application-specific software. This is accomplished using a combination of a virtual machine (the Java Card Virtual Machine, one version of which is contain in the jcop.exe referenced above) and a well-defined runtime library, which largely abstracts the applet from differences between smart cards. Using this technique one can run and debug both the Java Card code for the application that will eventually be embedded in a smart card, as well as a Java application that will be in systems that will use the smart card, all working jointly in the same environment.

In the case where the SEs in an array of SEs are database secure element representations, a SE card reader is not needed to interrogate the SE representations. In such systems the data may be acquired by using an electronic processor to translate the ISO 7816-4 protocol queries (commands) from the remote device into standard database queries and then translating the database responses into ISO 7816-4 responses for transmittal to the remote device. An array of SEs may include combinations of one or more types of secure element representations. That is, an array may include hardware representations and/or virtual hardware representations and/or database secure element representations.

The SE hardware implementation may be the preferred case by the financial transaction industry simply because of the more secure nature of controlling the removable SE that may be manufactured with secure data residing on the SE chip in a secure facility and then shipped to the remote system facility to be plugged in and activated and verified.

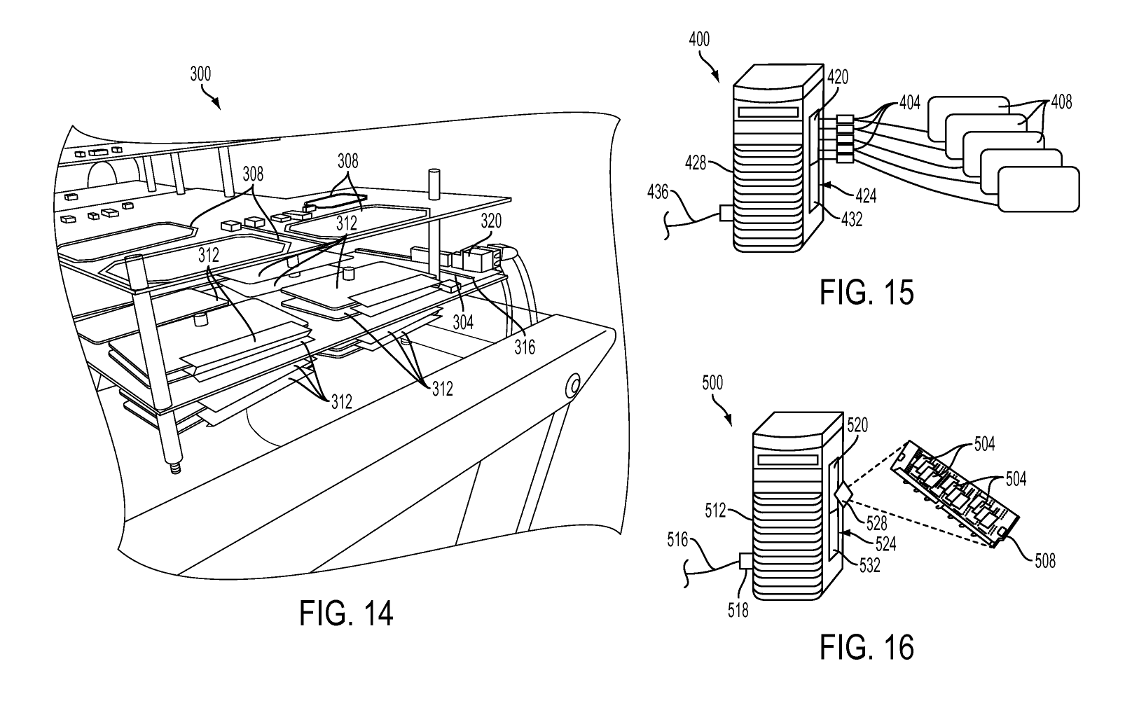

FIG. 14 illustrates a repository 300 that employs hardware representations of secure elements. The repository 300 includes at least one secure element reader 304, and in the embodiment illustrated the repository 300 includes one secure element reader 304 having four RFID antennas 308. In the embodiment of FIG. 14, the secure element reader 304 is a contactless (RFID) reader operating under ISO 14443A or B protocols. A repository (such as the repository 300) typically includes a plurality of secure element representations, and in the embodiment of FIG. 14 the repository 300 includes eleven secure element hardware representations 312 each of which is integrated into one of eleven bank-issued transaction cards. In the embodiment of FIG. 14 the secure element reader 304 is disposed adjacent to the plurality of secure element hardware representations 312. As used herein the term “adjacent to” refers to a spatial condition where two devices are very close to each other, such as being in the same electronics cabinet, or at least in the same room. A data server 316 is provided to communicate with the plurality of secure element representations 312 through the secure element reader 304.

In typical embodiments a data server (e.g., the data server 316) is a hardware/firmware device that includes a multitasking processor, such as a multithreading processor, or a parallel processor, or a time-shared processor, to communicate with a plurality of secure element representations (e.g., the secure element hardware representations 312) through a secure element reader (e.g., the secure element reader 304). Typically such communication is conducted according at least one part (e.g., part 1, part 2, part 3 or part 4) of the ISO7816 specification to extract at least a portion of the digital credential data from a the paired secure element representation. In some cases only the bus communication protocol of the ISO layer may be used, in other embodiments the data section (i.e., part −4) may be used, and in some cases several or all of the sections (i.e., parts −1 through part −4) of ISO7816 may be used. In the embodiment of FIG. 14 the secure element reader 304 includes a multiplexor in order to sequentially address the secure hardware element representations 312. Typically the multiplexor is part of the hardware at the reader circuitry level. In other embodiments the multiplexor may be provided in software. The multiplexing function allows a single secure element reader to rotate through multiple ports or antennas in order to address and communicate with a plurality of secure element representations. Such a configuration allows a data server (e.g., the data server 316) to conduct a plurality of command/response time-wise overlapping sessions with the plurality of secure element representations (e.g., the secure element hardware representations 312) without causing confusion about which card is being interrogated and which card is responding. The data server 316 also includes a network interface processor that communicates with the internet over an internet connection 320. The use a plurality of secure element hardware representations to store multiple different secure elements in a common processing environment in order to conduct a plurality of command/response time-wise overlapping sessions with the plurality of secure element hardware representations provides utility (as an SE repository) that is unexpected from the usual application a secure hardware representation, such as a single bank-issued card that is read by an SE reader at a point-of-sale terminal.

FIG. 15 illustrates an embodiment of a repository 400 that employs a plurality of contact readers 404 operating under ISO 7816. A separate dedicated reader is provided for each of a plurality of secure element hardware representations 408. In the embodiment of FIG. 15 the secure element hardware representations 408 are bank-issued cards containing a secure element chip that is accessible by a Universal Serial Bus (USB) connector, and the contact readers 404 are USB readers. A first portion 420 of a CPU 424 in a computer 428 is a multitasking data server to conduct a plurality of command/response time-wise overlapping sessions with the plurality of secure element hardware representations 408 through the plurality of contact readers 404. The USB standards typically limit the number of USB ports on a computer to 127 ports. A different bus architecture may be used to overcome that limitation, or a single USB reader may be configured to address multiple cards through electronic or even mechanical switching mechanisms. In the latter case the switching mechanism acts as a portion of a multitasking data server. In some embodiments (such as, for example, embodiments that employ contact readers as illustrated in the FIG. 15) a plurality of secure element representations may be disposed proximate to a secure element reader. As used herein the term “proximate to” refers to a spatial condition where two devices are close to each other, but may not be adjacent to each other. For example, two devices that are in the same building (but not the same room) are considered to be proximate to each other. The term “proximate to” encompasses devices that are “adjacent to” each other.

Continuing with FIG. 15, a second portion 432 of the CPU 424 is a network interface processor that communicates with the internet over an internet connection 436. The internet connection 436 to the second portion 432 of the CPU 524 provides addressability of the plurality of secure element hardware representations 408 over the internet. The use a plurality of secure element hardware representations to store multiple different secure elements in a common processing environment in order to conduct a plurality of command/response time-wise overlapping sessions with the plurality of secure element hardware representations provides utility (as an SE repository) that is unexpected from the usual application a secure hardware representation, such as a bank-issued card.

FIG. 16 illustrates a repository 500 that employs virtual hardware secure element representations. A plurality of instances of virtual hardware secure element representations (shown symbolically as elements 504) is provided in a memory 508 of a computer 512. These virtual hardware secure element representations 508 may be multiple instances of the Java Card software previously described. Each instance is programmed as if it were a different secure element. Typically each instance is a separately-running thread of a standard jcop.exe program. Each instance may be run from a DOS command line such as:

jcop.exe-port 50000

Running that command opens up a TCP/IP PORT number 50000 and, presuming that the computer is on the internet (such as per internet connection 516), the program listens for telnet terminal type data on the telnet port, shown symbolically as element 518. It is expecting ISO7816-4 data communications and will respond just like a real SE with response ISO7816-4 data. Thus, when that program is running on the computer 512, another DOS window may be opened on a different computer to communicate with that instance of jcop.exe by executing the following command line:

telnet 192.168.0.14 50000

where the 192.168.0.14 is the IP address of the computer 512 where the simulation program (jcop.exe) is running, and where 50000 is the port number that it is running on. A local I/O bus 520 is controlled by a CPU 424 in the computer 512 so that when the telnet window on the second computer connects to that IP address and port number on the first computer 512, standard command/response communications may be established by sending 7816-4 formatted data and getting the response from the designated virtual hardware secure element representation 504 back into the telnet window of the second computer.

In the embodiment of FIG. 16, a first portion 520 of the CPU 524 operates as a secure element reader using a local I/O bus 528 to communicate with the virtual hardware secure element representations 504. The instances of virtual hardware secure element representations 504 are a plurality of secure element representations proximate to the secure element reader (I/O bus 528). A second portion 532 of the CPU 524 is a data server to conduct a plurality of command/response time-wise overlapping sessions with the plurality of secure element representations (e.g., the virtual hardware secure element representations 504) through the first portion 520 of the CPU 524 that is operating as the secure element reader. The second portion 532 also includes a network interface processor that communicates with the internet over the internet connection 516. In the embodiment of FIG. 16 the secure element reader (i.e., the first portion 520 of the CPU 524) is disposed adjacent to the plurality of virtual hardware secure element representations 504. In other embodiments a secure element reader may be disposed proximate to the plurality of virtual hardware secure element representations. The internet connection 516 to the second portion 532 of the CPU 524 provides addressability of the plurality of secure element representations (504) over the internet. The use of multiple instances of the JCOP environment to store multiple different virtual hardware secure elements in a common processing environment in order to conduct a plurality of command/response time-wise overlapping sessions with the plurality of virtual hardware secure element representations provides utility (as an SE repository) that is unexpected from the usual application of the JCOP programming environment.

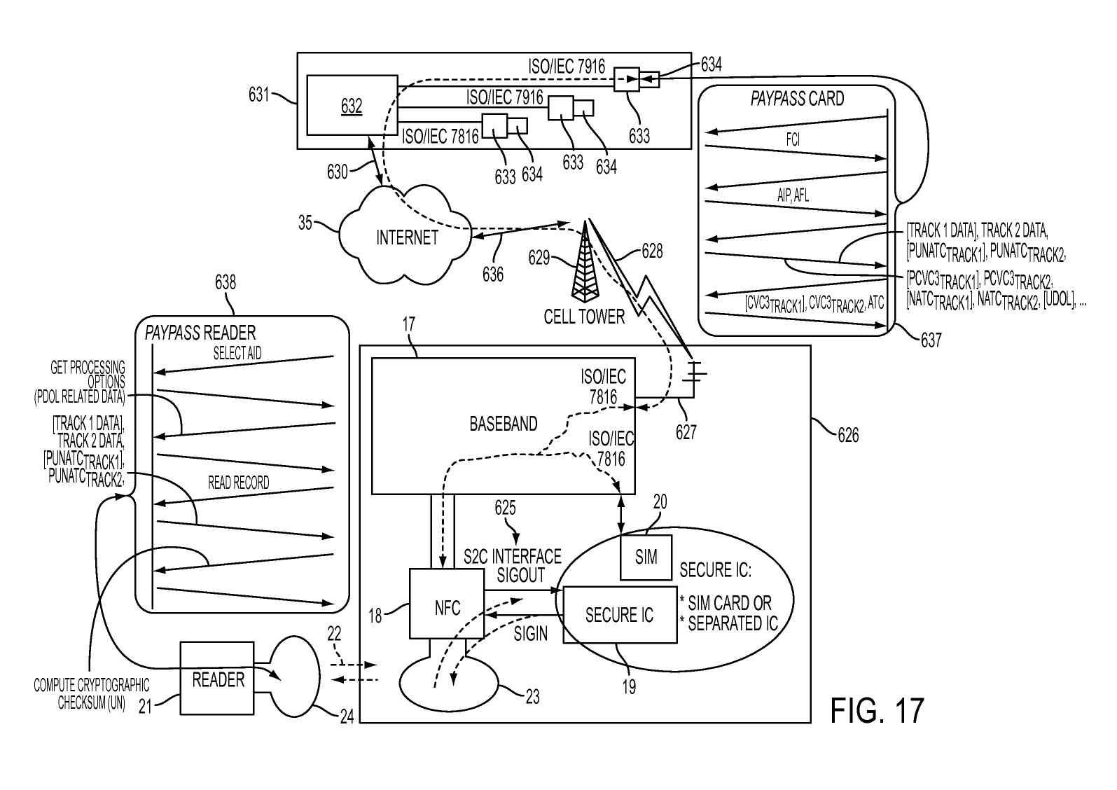

FIG. 17 describes an inner architecture of a mobile device 626 that supports NFC functionality and how that device may allow access to its attached secure elements as well as access to a secure element where the mobile device is remote from the secure element. A base band processor 17 is provided in the mobile device and the baseband processor 17 typically runs an OS (Operating System) to control all aspects and interfaces on the device including communication access to the SIM 20, NFC controller 18, Secure IC 19, or data that are eventually that are eventually sent to the internet 35. The NFC controller 18 acts as a router to determine where the communication is routed. When a mobile NFC device is presented to an RFID POS, the mobile device may emulate a card (pretend to be a payment card). When this happens the NFC controller 18 which is controlled by the baseband processor 17 in the mobile device may be configured to route interrogation commands and responses (such as communications 1, 2, 3, 4, 5, 6, 7, and 8 depicted in FIGS. 1 and 2) from the reader (interrogator) 21 to a secure element for processing and response. Thus an SE application that is used in a payment transaction may be configured to respond to interrogation commands the same or similar to the sequences described in FIG. 1 and FIG. 2. The commands and responses illustrated in FIG. 1 and FIG. 2 are comprised of a string of data that conforms to ISO/IEC 7816 specification. The baseband controller may choose to route the commands from the reader 21 to any secure element it chooses for processing. Some of the options include:
a. Routing ISO/IEC 7816-4 data through the NFC interface 18 to an embedded secure IC over its proprietary connected SE interface 625
b. Routing ISO/IEC 7816-4 data through the NFC interface 18 through the baseband processor 17, to an attached SIM card 20
c. Routing ISO/IEC 7816-4 data through the NFC interface 18 through the baseband processor 17, to an attached SD, miniSD, or microSD card that contains an SE
d. Routing ISO/IEC 7816-4 data through the NFC interface 18 through the baseband processor 17, over a data connection 627, 628, 629, 636, 35, 630 to a remote data server 632 using TCP/UDP/IP

All options a., b., c., and d. use APDU data to exchange information between the RFID reader 21 and the applications located in an SE located in the mobile device 626 or in a remote SE 634. It is important to note that the remote SE 634 may also be created with software and emulated within the remote system 631. The interrogation example mapped out in FIGS. 3 and 4 may be implemented on this system in all 4 modes a., b., and c., and d. above. Thus the remote system SE 634 may perform the identical interrogation on a remote secure element 634

It is important to note that at the ISO/IEC 7816-4 (APDU) level, an entire interrogation similar to those described in FIG. 1, and FIG. 2 may be carried out from a RFID POS reader 21 through an NFC enabled mobile device 626, through a data connection over the interne 35 to a remote system 631 that contains the actual SE 634. An example of reader commands is illustrated in element 638 as a PayPass reader. The PayPass reader 638 shows an exemplary sequence of ISO/IEC 7816-4 APDU commands and responses that may be pushed through the reader 21 and end up at the remote SE 634. Element 637 shows an example of APDU commands that are received by the remote SE 634 and the appropriate response that is issued as defined by the 7816-4 application for MASTERCARD PayPass. Elements 638 and 637 show how FIG. 2 may be broken up so that the PayPass card may be hosted on a remote SE 634 on a remote system 631 and show that the PayPass reader may be an RFID POS 621.

The remote system 631 has a connection to the internet 630 and connections to an array or plurality of SE readers 633 that are each connected to an SE 634. A server or set of servers 632 may be used for pairing the connections originating at the mobile NFC device 626 to the correct SE 634 within the remote system 631. The server or set of servers 632 may, for example, be one or more computers each of which has access to control one or more of the SE readers 633.

The data connection described in FIG. 17 (i.e., the path 627, 628, 629, 636, 35, 630) is a TCP/UDP/IP connection that is offered by most cellular carriers over a cellular network and cellular towers 629 using a cellular link 628. The TCP/UDP/IP connection may run socket software that allows for raw data to be transmitted from one end of the data connection 626 and the other 631 and vice versa. The data packets within the socket software may be configured to exchange data that contains ISO/IEC 7816-4 data.

In alternate embodiments a stationary device may be used in place of the mobile device 626 depicted in FIG. 17.

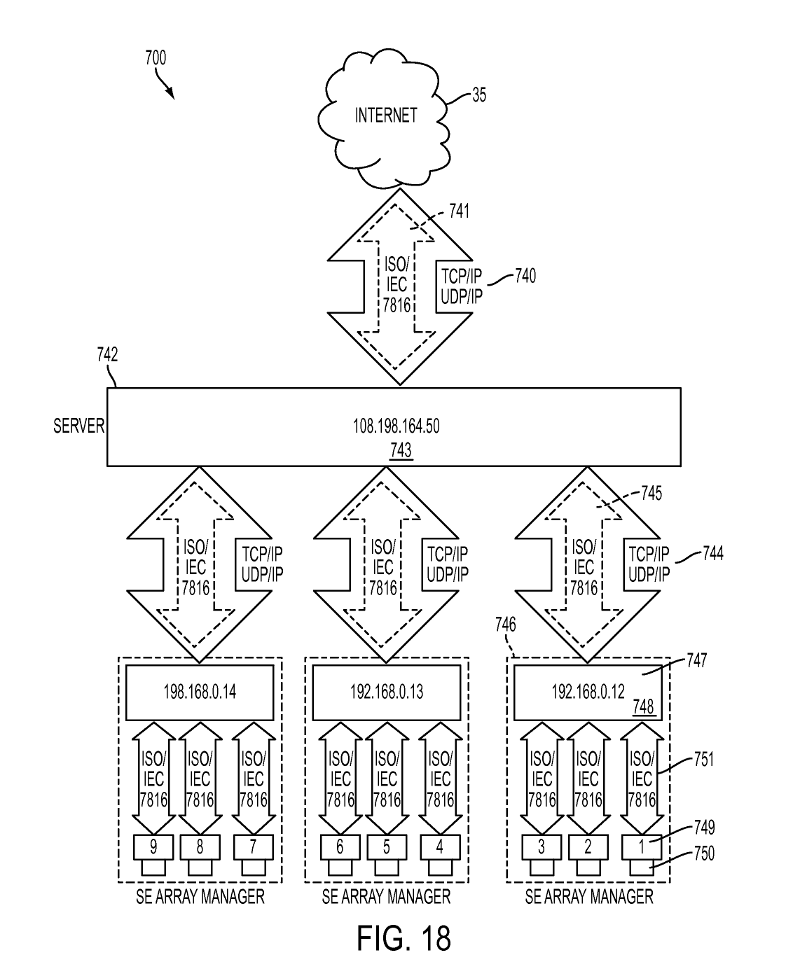

FIG. 18 describes a remote system 700 that is capable of bridging a data (TCP/UDP/IP) connection through the internet 35 to a single addressable SE reader 749 and SE 750. Communications 740 and 741 show how a data link (TCP/UDP/IP) 740 may be used to pass ISO/IEC 7816-4 APDU data 741 to a remote server 742. In this example the remote system is identified on the internet through the IP address 743. The remote system is comprised of a remote server 742 that routes the connection to an internet network of attached SE Array Managers 746. The TCP/UDP/IP data 740 that enters this remote system and is routed to the internal SE Array Manager 746 over TCP/UDP/IP 744 contains data that uses the protocol for ISO/IEC 7816-4 APDU data 741 and 745. Each SE Array Manager 746 contains an internally unique IP address 748 within a TCP/UDP/IP socket server 747. Each TCP/UDP/IP socket server 747 is responsible for receiving ISO/IEC 7816-4 APDU data 745 and routing as it as ISO/IEC 7816-4 APDU data 751 to the appropriate addressable SE reader 749 and SE 750.

FIG. 18 further illustrates one method to create a communication channel from the remote system to the mobile device over TCP/UDP/IP using socket server and client methods. Identification data from the mobile device may be used to set up a socket connection all the way through the remote server 742 to the TCP/UDP/IP socket server 747. The data that are sent over the socket server and client may be formatted to be ISO/IEC 7816-4 APDU data. The APDU command may enter the socket server 747 and be routed to the appropriate SE reader 749 and SE 750 and the response APDU may be sent from the SE 750 and SE reader 749 back to the remote mobile device through the SE Array Manager socket server 748, the remote system socket server 742, and through the internet 35 and be received by the socket client on the remote mobile device.

FIG. 18 also depicts a plurality of remote SEs that are each addressable and may be accessed by a plurality of remote mobile devices independently. The descriptions herein above describe how a single remote mobile device may connect to a remote system and specifically a single remote SE to complete a transaction. This same process may occur through this same system concurrently with different SE's in the system from different remote mobile devices.

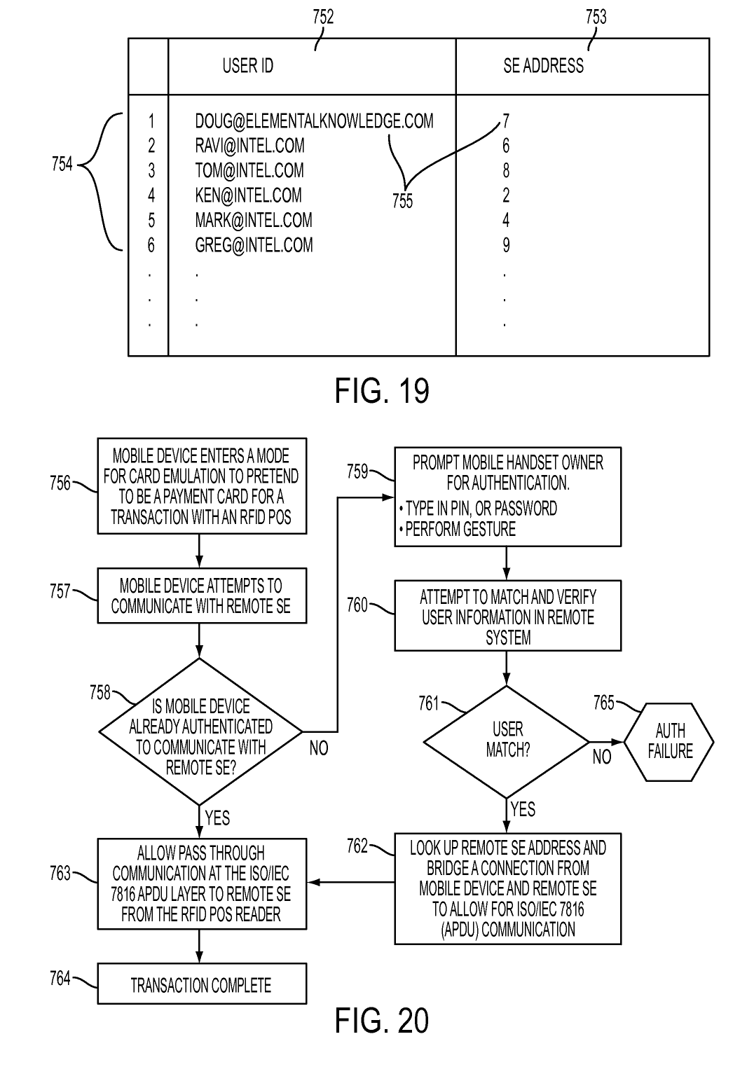

FIG. 19 depicts a table in a database that may be used to identify which remote SE within a remote system described in FIG. 18 that a user and particular mobile device may be attached to. Unique row identifiers 754 are provided in the table. Each row contains related data. The other columns of this table are the User ID 752 and the SE Address 753. The SE address is the unique address within the remote system for a particular SE. The table of FIG. 19 further illustrates a relationship 755 between two fields that form a row in the database. This table in FIG. 19 may be used to properly match a remote user or remote mobile device with the address of a particular SE.

In order to connect to the remote system and create the connection to the correct SE for that user or mobile device, it is generally necessary that the mobile device must be validated by the remote system. At a minimum, validating a mobile device by a repository involves pairing a particular secure element or secure element representation to a specific mobile device. Generally this involves establishing at the repository a digital database that lists at least one secure element representation identifier for each of a plurality of mobile device identifications.

FIG. 20 describes one process flow for allowing a data connection between a mobile device and remote hosted secure element. Step 756 describes how a mobile device that supports NFC is initiated and presented to a RFID POS reader in order to make a payment transaction. The phone is placed into a mode that is referred to as card emulation mode where the NFC interface on the phone pretends to be contactless RFID card. The phone has a bit more control to select which card is presented to the POS. The subject of this patent describes how the NFC mobile device has the ability to use a SE for the transaction that is not physically located in the mobile device. This may be done be creating a data connection to a remote SE for which is used for the payment transaction. In step 757, while the phone is being placed into card emulation mode, the connection to the remote SE that will be used for emulation is attempting to connect. As illustrated in step 758 there is a chance that the connection is already open in which case the flow in FIG. 20 will simply allow the ISO/IEC 7816-4 APDU data to pass directly through the connection to the remote SE and back 763 successfully completing the transaction 764. There is also a chance that the connection to the remote SE does not exist and needs to be created, as described subsequently in step 762.

Typically systems require that a mobile device “authenticate” itself with a remote hosted secure element. The method of authentication to the remote system that is described in FIG. 20 may, for example, be initiated and completed using HTTPS/SSL (Hypertext Transfer Protocol Secure/Secure Socket Layer (SSL) or Transport Layer Security (TLS)) web services. Authentication may also be initiated and completed using a telephone link, such as a cell-phone connection. In some embodiments authentication is facilitated through a remote system authorization server. As used herein the term “remote authorization server” refers to an electronic computer or set of computers configured for the purpose of approving or disapproving access to a particular secure element by a particular mobile device or stationary device. In some embodiments a remote system authorization server may be configured to access secure element representations that may be either proximate to the remote authorization server or that may be proximate to the remote authorization server, and in such embodiments the remote system authorization server is considered to be a remote repository having a plurality of secure element representations. The mobile device connecting to the remote system is able to pass various credentials to the remote system such as user ID, passwords, PIN, “gesture signal,” unique electronic communication device identity number, and so on securely to the remote system for mobile device validation 759. In steps 760 and 761 the system attempts to match and verify the user information in the remote system. Where a gesture signal is used, the verification includes an assessment as to whether the gesture signal is a valid gesture signal (i.e., a gesture signal that is expected by the remote system). Upon a successful match the remote system is said to “validate” the remote device, and the remote system opens up a communication channel (step 762) to the appropriate SE within the remote system and creates a handle to that communication channel that may be used to access it from the remote mobile device. When a communication link is established between a mobile device (or a stationary device) and a particular SE in a repository, the device and the particular SE may be described as being “paired” with each other. Once the mobile device is paired with a particular SE the remote system (repository) may securely pass back over HTTPS/SSL a shared encryption key and handle to the communication channel that may be used for continued communication over that communication channel through a TCP/UDP/IP data socket 762. If the authorization fails (step 765), the connection to the remote SE is not opened, and the process ends. When the remote device receives the shared encryption key and handle to the communication channel to a particular SE on the remote system, the ISO/IEC 7816-4 APDU commands from the RFID POS may be passed to this remote hosted SE through a socket connection and the data may be encrypted with the shared encryption key. The remote system may decrypt the data and send it to the correct SE within the remote system. The remote system may then send the response APDU from the SE back to the remote mobile device in a similar manner. The remote mobile device may forward this response APDU back through the NFC interface to the RFID POS reader.

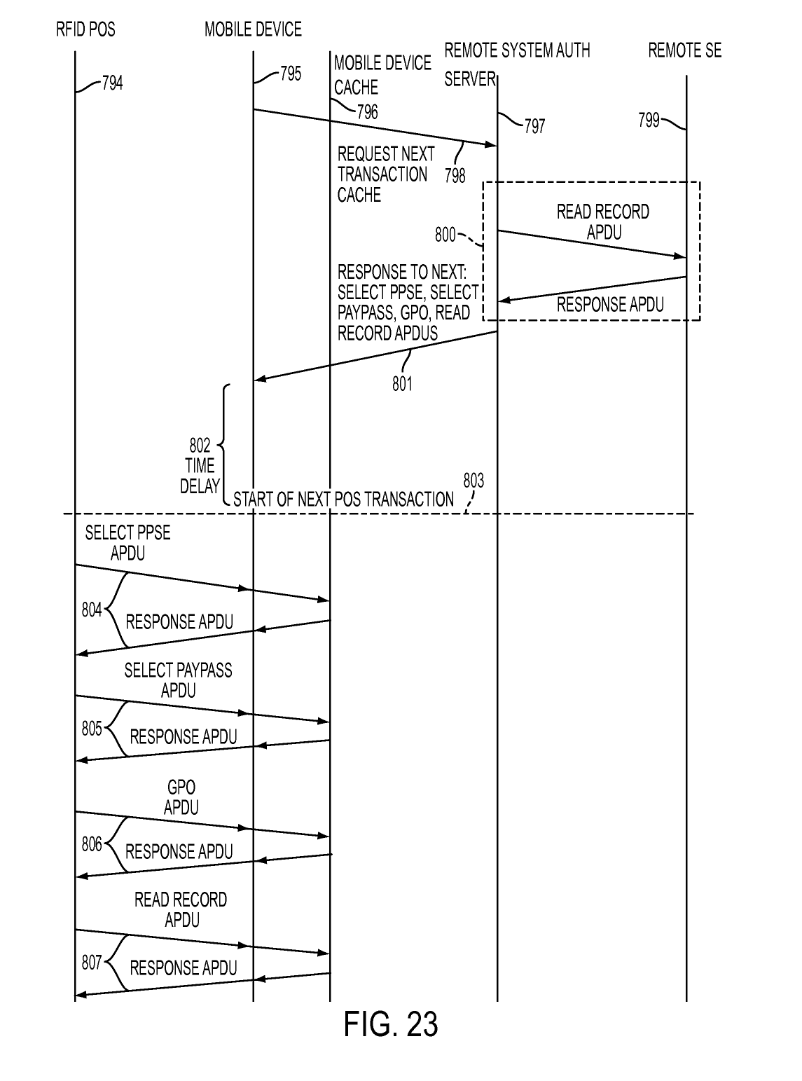

Some electronic communication devices (such as a mobile device) have memory for storing at least a portion of digital credential data as cached data. Such electronic communication devices are configured to send the cached data as at least a portion of a device response communication. When such an electronic communication device authenticates with a secure element representation, cache data can be copied from or extracted from data within a single secure element representation that is specifically matched or “paired” to an electronic communication device and may be provided to the electronic communication device, such as in FIG. 23, element 801. In such embodiments the electronic communication device may be paired with the single secure element representation for the purpose of extracting or copying cache data and may not be paired for any subsequent command/response communications. Such cache data are a “cached portion” of a set of digital credential data, and in some embodiments this cached portion is all of the digital credential data that are needed to complete a transaction. In some embodiments the cache data may include an ISO 7816-4 protocol response communication. In some embodiments the cache data may also include ISO7816-4 protocol command communication for the purposes of matching or analyzing it against other incoming ISO7816-4 protocol command communication data to determine which ISO7816-4 protocol response communication from the cache to use.

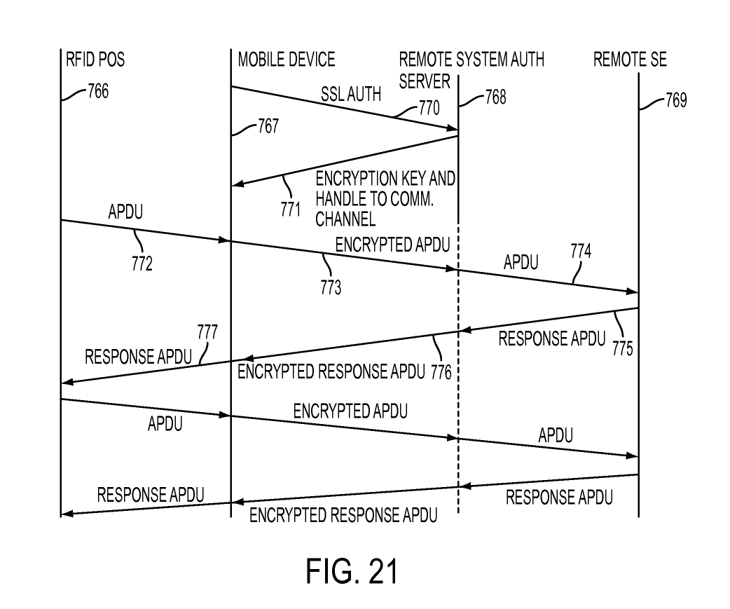

FIG. 21 illustrates an authorization and communication process in more detail. The vertical line 766 represents the RFID POS entity. The vertical line 767 represents the mobile device. The vertical line 768 represents a remote system authorization server, and the vertical line 769 represents the remote hosted SE. As shown in FIG. 21, the mobile device 767 may interact with a remote authorization server (e.g., remote authorization server 768) in order to facilitate the access of digital credential data from a remote hosted SE (e.g., remote SE 769).

In the example of FIG. 21, a communication channel is opened between the RFID POS 766 and the remote SE 769. Authorization over SSL is initiated where credentials 770 are sent to the remote authorization server 768. The remote authorization server 768 verifies the credentials and sends back a successful response 771 which contains a handle to a communication channel and an encryption key. The mobile device 767 may then open a channel to the remote SE 769. At that point APDU command and response APDUs may be sent securely between the RFID POS reader 766 and the remote SE 769 and back through the mobile device 767. An APDU command 772 is sent from the RFID POS reader 766 to the mobile phone 767, which may encrypt that APDU as command 773 and forwards an APDU command 773 on to the remote system 768 and on to the remote SE 769 as APDU command 774. In some embodiments the command communications 773 and 774 comprise at least a portion of the command communication 772 from the RFID POS 766 to the mobile device 767. In some embodiments the mobile device 767 may know ahead of time what the RFID POS 766 will command the mobile device 767 in the APDU command 772 in advance of actually interacting with the RFID POS 766. In such cases the command 773 may have been sent already sent by the mobile device 767 before the command 772 was received by the mobile device 767 from the RFID POS 766. The return APDU response from the SE is delivered back to the RFID POS through the communication channel using the handle provided by the response 771, via communications 775, 776, and 777.

With some data networks that pass TCP/UDP/IP information there are network delays and latencies that contribute to delays for round trip information exchange with a destination. With many embodiments disclosed herein, data are intended to go round-trip from a mobile device to a remote SE. Many payment applications that communicate with an SE may require a plurality of commands and responses to the SE for each transaction carried out by an interrogation from the POS RFID reader. Each or some of these command and responses to the SE may be subject to network delays and latency. Prolonged delays during a transaction with the RFID POS may cause an unsatisfactory user experience. Here is an example of a delay that was recorded during evaluation of an embodiment described herein:
a. Card transaction with a MASTERCARD PayPass plastic card and a RFID POS reader was measured to take ˜200 ms
b. Card transaction with a remote SE programmed with the MASTERCARD PayPass application over a 3G network managed by Verizon through a mobile handset was measured to take ˜600 ms

The remote SE took ˜400 ms longer in the above example due to network latency and delay during the SE interrogation.

A local cache (a memory located in the mobile device for data caching) may be implemented for use in some embodiments. Many of the responses to a 7816-4 APDU commands or queries are static and unchanging in a payment application on a SE. For this reason, a cache system may be configured to respond locally for these static information requests with the known 7816-4 APDU data responses, and to only generate real-time commands the remote SE in the event that the response 7816-4 APDU data are dynamic or changing with each transaction. This should limit the number of round trip data requests to the remote SE. Because each round trip request to the remote SE is subject to network delay and latency, a relatively significant total transaction time savings may be realized. The main advantages of implementing a caching system in the current invention is to save over-all time to perform a full transaction with a payment card application between a RFID POS reader through a mobile device to a remote SE.

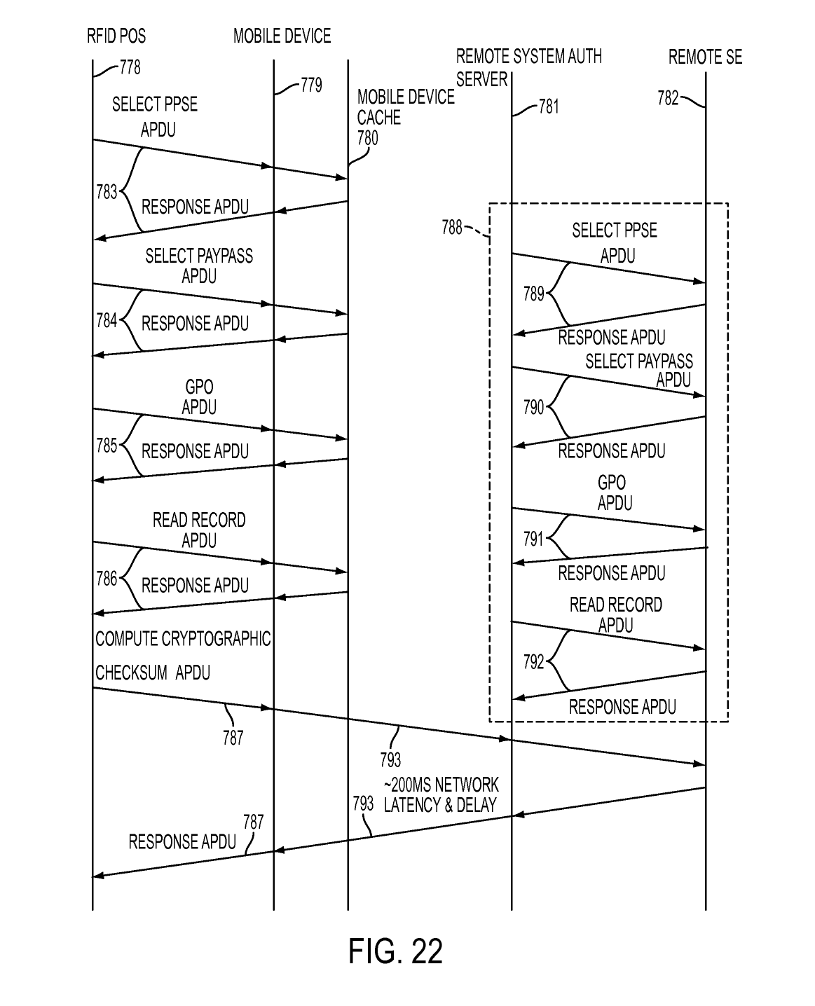

FIG. 22 illustrates an example of caching being used during a MASTERCARD PayPass transaction between a RFID POS and a remote SE. The vertical line 778 represents the RFID POS entity. The vertical line 779 represents the mobile device. The vertical line 781 represents the remote system authentication server, and the vertical line 782 represents the remote hosted SE. The vertical line 780 represents the caching system in the mobile device.

The MASTERCARD PayPass specification indicates that the response to the Select PPSE APDU 83 will always be the same:
a. APDU to the card for Select PPSE APDU:
   00 A4 04 00 0E 32 50 41 59 2E 53 59 53 2E 44 44 46 30 31 00
b. APDU response from the card for Select PPSE APDU is ALWAYS:
   6F 23 84 0E 32 50 41 59 2E 53 59 53 2E 44 44 46 30 31 A5 11 BF 0C 0E 61 C 4F 07 A0 00 00 00 04 10 10 87 01 01 90 00
      In some embodiments the fact that the APDU response from the card for Select PPSE APDU is ALWAYS a prescribed sequence is used to advantageously cache this response and then the caching system 780 may respond to this APDU without making a command all the way to the remote SE over the data network.

The MASTERCARD PayPass specification indicates that the response to the Select PayPass AID APDU 84 always be the same:
a. APDU to the card for Select PayPass AID APDU:
   00 A4 04 00 07 A0 00 00 00 04 10 10 00
b. APDU response from the card for Select AID APDU is ALWAYS:
   6F 17 84 07 A0 00 00 00 04 10 10 A5 0C 50 0A 4D 61 73 74 65 72 43 61 72 64 90 00
      This prescribed response to this APDU may also be cached and the caching system 780 may respond to this APDU without making a command all the way to the remote SE over the data network.

Furthermore, the MASTERCARD PayPass specification indicates that the response to the GPO (Get Processing Options) APDU 785 always be the same:
a. APDU to the card for GPO APDU:
   80 A8 00 00 02 83 00 00
b. APDU response from the card for GPO APDU is ALWAYS:
   77 0A 82 02 00 00 94 04 08 01 01 00 90 00
      This means that the response to this APDU may be cached and the caching system 780 may also respond to this APDU without making a command all the way to the remote SE over the data network.

The MASTERCARD PayPass specification indicates that the response to the Read Record APDU 786 is to always be the same for a particular card that has been personalized, but will be different from personalized card to a different personalized card:
a. APDU to the card for Read Record APDU:
   00 B2 01 0C 00
b. APDU response from the card for Read Record APDU is ALWAYS for a specific card:
   70 7F 9F 6C 02 00 01 56 3E 42 35 34 31 33 31 32 33 34 35 36 37 38 34 38 30 30 5E 53 55 50 50 4C 49 45 44 2F 4E 4F 54 5E 30 39 30 36 31 30 31 33 33 30 30 30 33 33 33 30 30 30 32 32 32 32 32 30 30 30 31 31 31 31 30 9F 64 01 03 9F 62 06 00 00 00 38 00 00 9F 63 06 00 00 00 00 E0 E0 9F 65 02 00 0E 9F 66 02 0E 70 9F 6B 13 54 13 12 34 56 78 48 00 D0 90 61 01 90 00 99 00 00 00 0F. 9F 67 01 03 90 00
      This means that the response to this APDU may be cached and the caching system 780 may respond to this APDU without making a command all the way to the remote SE over the data network, UNLESS the card on the SE has changed to a different card, in which case the caching system should send this command to the remote SE for processing.

The MASTERCARD PayPass specification indicates that the request and the response to the Compute Cryptographic Checksum APDU 787 will always be different for each transaction. This means that this APDU will always need to be processed by the actual remote SE through the data network. Communication 793 indicates the estimated or example of network processing time for this single APDU command and response 787. The over-all example in FIG. 22 illustrates how there is potentially only a single command and response that need to happen in real time over the data network 793 as a result of implementing a caching system.

In this specific example in FIG. 22, communications 788 illustrate one method to maintain the proper state of the remote SE 882 when a caching system is used. It is important that the remote SE 782 maintain the same processing state as the system is expecting when introducing a caching system. For this reason, it is important to actually issue the APDU commands to the remote SE in order to bring that SE to the appropriate system state. The dashed line illustrates how these ghost commands may be issued by the remote system in order for the SE to maintain an up-to-date state. The communications 789, 790, 791, and 792 mirror the APDU commands and responses 783, 784, 785, and 786 managed by the caching system 780.

FIG. 23 illustrates a slightly different caching concept using a VISA payWave transaction as an example. In this figure, the entire transactional sequence with all APDU commands and responses is cached at a separate time 802 prior to the actual transaction. In this example illustrated in FIG. 23, the RFID POS 794 does not initiate the initial request to the remote authentication server 797. Instead, it is initiated by the mobile device application at some prior time from the actual RFID POS transaction. When the mobile device 795 makes a request to the remote system authentication server 797, the remote system authentication server 797 either retrieves caching information from a database, or from making a request to a HSM (Hardware Security Module) or other storage system or, if needed, makes commands with a remote SE 799 as indicated by the dotted box in the figure with a read record request 800 to the remote SE 799. The remote SE 799 may be a hardware representation of a secure element or a software representation of a secure element. This example is particularly pertinent in the event that the response to the read record request 800 is dynamically changing data with each individual transaction with the SE. When all known responses to the remote SE transactional command(s) are gathered, the entire set of caching information may be passed back to the mobile device 795 as shown in communication 801. In communication 801 the SE responses to Select PPSE, Select PayPass, GPO, and Read Record APDU is passed back to the mobile device all at once.

FIG. 23 illustrates an unspecified time delay 802 after communication 801 until the actual start of the RFID POS transaction 803. During this time delay 802 the cached APDU command and response data may be stored safely in non-persistent memory or RAM in a cached format 796. An alternative is to store this data safely through encryption techniques in a persistent manner.

Communications 804, 805, 806, and 807 illustrate the real time transaction with an RFID POS at a later time 802 than the previous interaction with the remote authentication server 797. In this example each and every response APDU command that the RFID POS requested was replied to locally by the mobile device cache 796.

In various contactless payment systems (such as RFID systems) the POS terminal sends a “select file” command using a VISA AID starting with A000000003. However generally such systems do not check to see that the secure element that is read is actually a VISA application. Some embodiments disclosed herein take advantage of this situation to format a digital credential that is identical to a static magnetic stripe card that conforms to ISO7813 but that does not have a beginning Personal Account Number (PAN) digit (as defined in ISO7813) that is the numeral “4,” and to then present that digital credential data to a POS terminal running the VISA application. This is quite unexpected because one would logically expect that the VISA application running the POS system would require that first digit of the PAN on the secure element to be “4,” which designates the SE issuer to be VISA. However, that is not a requirement for the VISA AID system, which allows various embodiments disclosed herein to use a VISA application that is installed on the POS (with a AID starting with A000000003) to process many other (different) card issuer's SE cards, even though there is not and application for that issuer's card on that POS hardware.

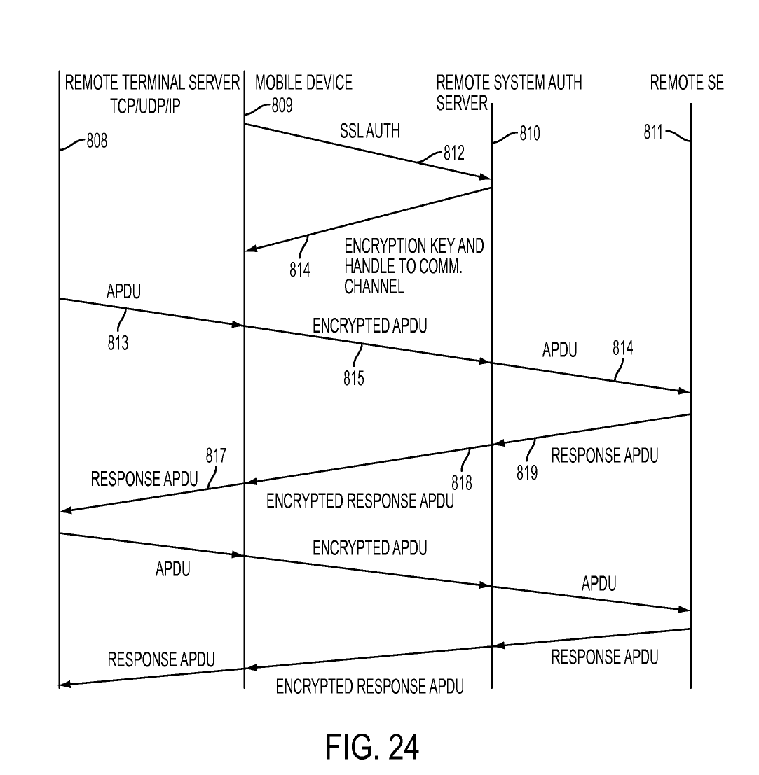

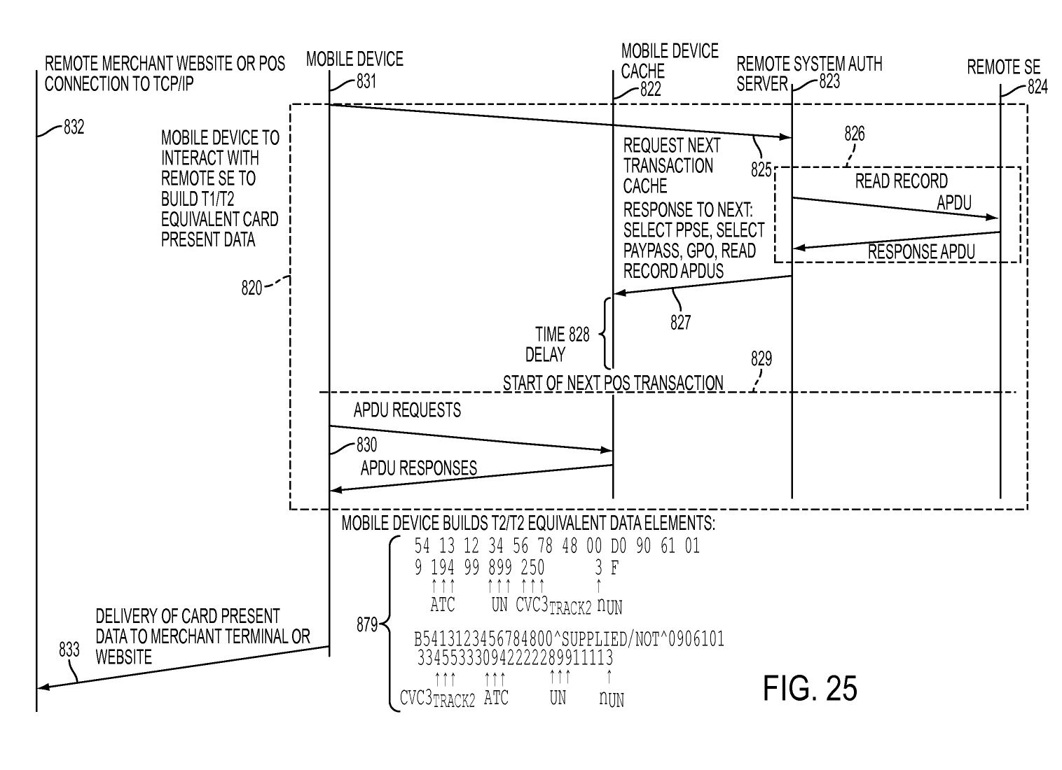

FIG. 24 closely resembles previous FIG. 21. The main difference between FIG. 21 and FIG. 24 is that the RFID POS 766 represented in FIG. 21 is replaced by a remote terminal 808 in FIG. 24. A mobile device 809 depicted in FIG. 24 corresponds to the mobile device 767 in FIG. 21. A remote system authorization server 810 corresponds to the remote authorization system server 768 of FIG. 21. A remote SE 811 corresponds to the remote SE 769 of FIG. 21. Communications 812, 814, 813, 815, 816, 819, 818, and 817 in FIG. 24 correspond to communications 770, 771, 772, 773, 774, 775, 776 and 777 respectively in FIG. 21. The remote terminal server 808 in FIG. 24 may communicate to the mobile device 809 with the same exact APDU data protocol, but the main difference is that instead of the communication happening over 13.56 MHz NFC radio, the communication occurs over TCP/UDP/IP data protocol. Aside from that difference, this figure and the elements depicted illustrate that the same functions and communications with a remote SE may be accomplished regardless of the nature of the communication link (13.56 MHz carrier, or TCP/UDP/IP).

FIG. 25 illustrates a mobile device 831 having the capability to collect card present transaction data from a remote system authentication server 823 using various different methods disclosed herein, may use the card present data that was achieved from a remote SE 824 and/or remote system authentication server 823 and present that data to a remote merchant web site or remote merchant point-of-sale 832 in order to make a more secure transaction with that remote merchant site or POS 832. This process is illustrated by a group of communications 820. The system of FIG. 25 includes a mobile device cache 822 which may be populated with data using command 825 to secure response 827 through a process 826 that interacts with the remote SE 824. This process may occur in advance of needing the data, as indicated by a time delay 828, before the start of a POS transaction 829 at which time a further command/response sequence 830 occurs. In this example the mobile device 831 contains the logic to parse through the APDU commands and responses to the remote SE 824 and remote system authentication server 823 and create properly formatted track 1/track 2 equivalent data 879 that represents a card present payment transaction and pass that data or parts of that data directly to the merchant remote web site or remote POS 832 in order to consummate the payment transaction as a card present transaction 833.

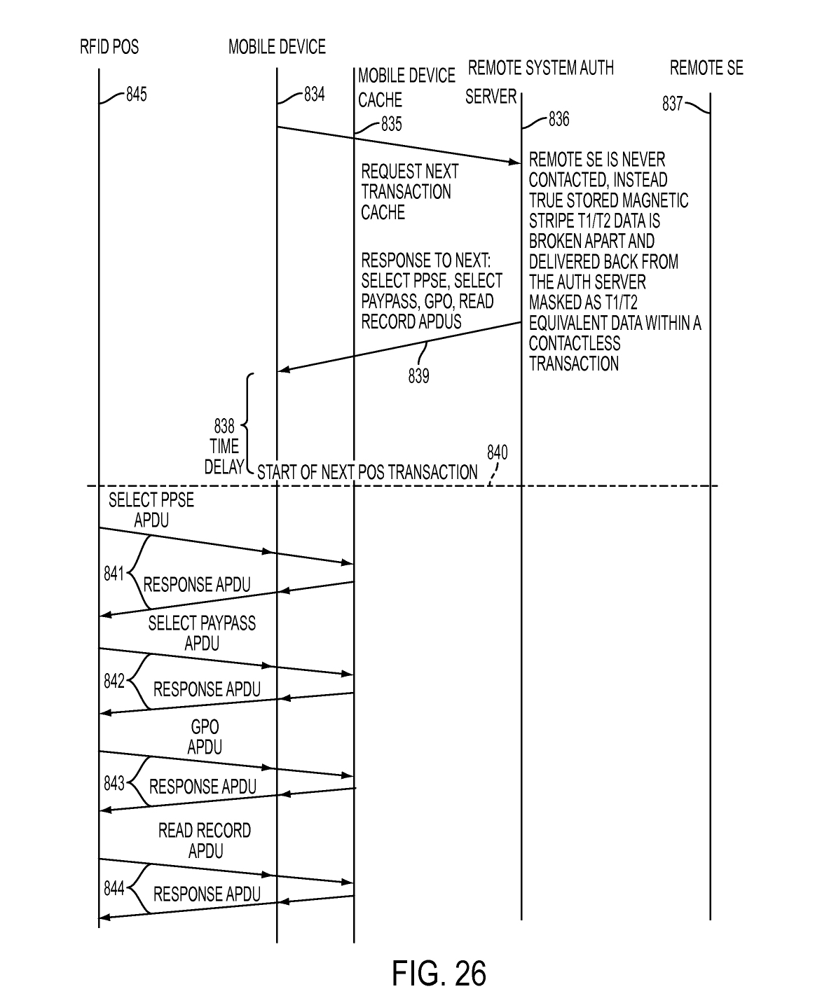

The system depicted in FIG. 26 is very similar to that depicted in FIG. 23, with a mobile device 834 in FIG. 26 corresponding to the mobile device 795 of FIG. 23, the mobile device cache 835 corresponding to the mobile device cache 796, and APDU communications 841, 842, 843 and 844 corresponding to APDU communications 804, 805, 806, and 807. The major difference between the system in FIG. 26 and the system in FIG. 23 is that in the system of FIG. 26 a remote SE 837 (corresponding to the remote SE 799 of FIG. 23) is not used (not transacted with). The reason that it is possible to complete a transaction without a remote secure element interaction is that the architecture defined herein may be used to deliver standard magnetic stripe data to an RFID POS 845 (or other remote terminal) through contactless APDU commands 839, where the actual data inside the transactions is generated from standard magnetic stripe data and stored at the remote system authentication server 836. The magnetic stripe data may be populated into the remote system authentication server 836 by simply swiping an existing magnetic stripe card with a magnetic stripe card reader and populating that data accordingly into the remote system authentication server 836 database. There are other ways to populate the data into the authentication server 836 database such as receiving the data directly from card issuers or generating the data from an HSM (Hardware Security Module). These data are typically the same data that may be stored in an SE.

The configuration of FIG. 26 closely represents an embodiment which employs secure element software representations where the secure element software representations are in the remote system authorization server 836. Much of the transaction scenario in FIG. 26 is identical to FIG. 25 including the time delay 838 (828 in FIG. 25) prior to the actual transaction 840 (829 in FIG. 25) and the delivery of the transactional data from the server 836 (823 in FIG. 25). This type of data substitution is possible with existing contactless APDU commands as defined in the VISA payWave specification. That specification allows for a transaction with an RFID POS to be made using these commands:
a. Select AID: communication 11 FIG. 3
b. GPO: communication 12 FIG. 3
c. Read Record: communication 13 FIG. 3

The read record command for VISA payWave indicates there may be 3 data elements with the tags:
a. Tag 57: Track 2 Equivalent Data
b. Tag 5F20: Cardholder Name
c. Tag 9F1F: Track 1 Discretionary Data

Specifically Tag 57 is a required tag that presents Track 2 Equivalent Data to the POS transaction. This format of the data is processed by the RFID POS and converted into ISO7813 data format. An example of this data conversion is this:
a. Raw Tag 57 data:
   i. 54 13 12 34 56 78 48 00D0 90 61 01 90 94 99 89 92 50 3F
b. Converted to ISO 7813 format:
   i. ;5413123456784800=09061019094998992503?

In this instance the data conversion is almost a direct conversion, just adding the start sentinel ‘;’, the end sentinel ‘?’ and substituting “=” the “D” and removing the trailing padding ‘F’ gives the ISO7813 equivalent data. ISO 7813 data are used to send out for authentication processing for both magnetic stripe cards and contactless cards. Because of this, the actual data in Tag 57 may be gathered and populated from a regular magnetic stripe card as described in FIG. 14 tasks in the remote system auth server 836.

Extrapolating this concept displayed in FIG. 26 further, it is possible to substitute any Track 2 data into tag 57 of the read record APDU response. Some substitution examples are:
a. Mastercard data: 54 13 12 34 56 78 48 00 D0 90 61 01 90 94 99 89 92 50 3F
b. VISA data: 44 13 12 34 56 78 48 00 D0 90 61 01 90 94 99 89 92 50 3F
c. AMEX data: 34 13 12 34 56 78 48 00 D0 90 61 01 90 94 99 89 92 50 3F
d. Any propriety data format (McDonalds Arch Card): 64 13 12 34 56 78 48 00D0 90 61 01 90 94 99 89 92 50 3F

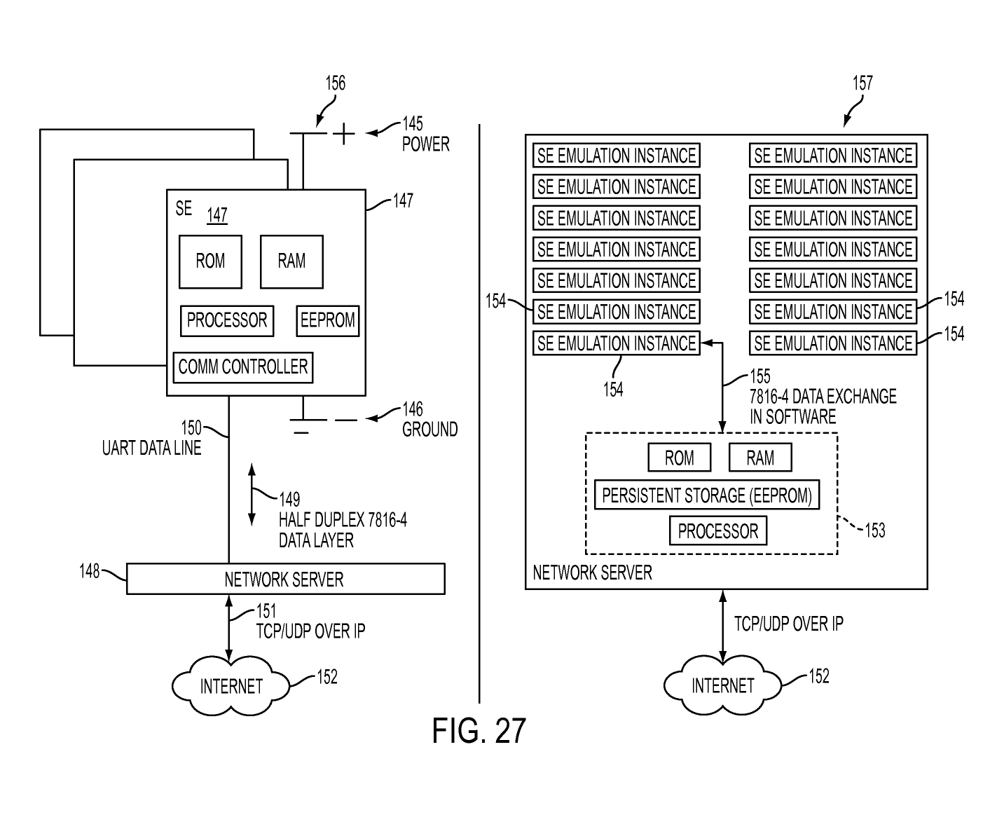

FIG. 27 illustrates two embodiments of SE repositories, repository 156 and repository 157, to illustrate some similarities between hardware representations of an SE 147 and a software representation of an SE 154. In both cases the mobile device that is accessing the secure element representation is remote from repository 156/157, and the secure element representation is accessed over an internet 152 or other global network. In the hardware based SE side (i.e., repository 156 on the left side) of the figure, the hardware representation of the SE 156 is a “chip” that may be mounted to a circuit board or located in a physical plastic card or a SIM module. Each such form factor has both power 145 and ground 146 lines, and also includes a data line 150 that is configured to be half duplex communication over various serial data rates 149. The SE 147 is a fully functional processor chip that includes ROM, RAM, communications controller, EEPROM or persistent memory and a processor. It is addressable by and communicated with by a Network Server 148 provided the correct conversion hardware is in place to do so. Such conversion hardware is depicted in FIG. 18 where the SE array manager 746 sits in between the network server 742 and the SE's 750. One job performed by the SE array manager 746 is to translate TCP/UDP/IP communication packets from the network server 742 into 7816-4 data packets for the SE's and vice versa.

Returning to FIG. 27, the Network Server 148 serves as a communication server for communicating with the SEs and as a network interface with the internet 152. The APDU data communication (typically standard SE communication) between the Network Server 148 and the SEs 147 is extended to the Internet 152 over TCP/UDP/IP protocol. In FIG. 24, for clarity of illustration, details are depicted for only one hardware representation of SE 147.

The right side of FIG. 27 shows a repository 157 where the function of the SE are handled as multiple software representations 154 (SE Emulation Instances) in a single computer or a bank of several computers. In this configuration, there is no separate hardware that is the SE. In the embodiment of FIG. 27. the functions of the SEs are provided as software representations depicted as SE Emulation Instances 154 that are established entirely in software and contained inside a Network Server 153. The communication format of APDU 7816-4 structure 155 may also be provided by the software of the Network Server 153. A general purpose computer or server typically has all the necessary components (such as ROM, RAM, Persistent Memory, and a processor) that are necessary to provide the SE software representations. The software architecture within the Network Server 153 may be arranged as such to divide and address many different SE software representations 154 within a single computer. In the same manner the hardware based SEs 147 are exposed to the Internet over TCP/UDP/IP, the software representations of the SEs 154 are also be exposed to the Internet.

FIG. 27 illustrates that either of the depicted architectures (i.e., the hardware representations 147 and the software representations 154 are functionally interchangeable and are interoperable from the external world over the Internet. FIG. 27 also suggests that a repository (such as repository 157) using software representations of SEs may be more easily scalable than a repository (such as repository 156) using many hardware representations. The use of virtual hardware representations may be a good compromise between the security of hardware representations and portability and scalability of database secure element representations.

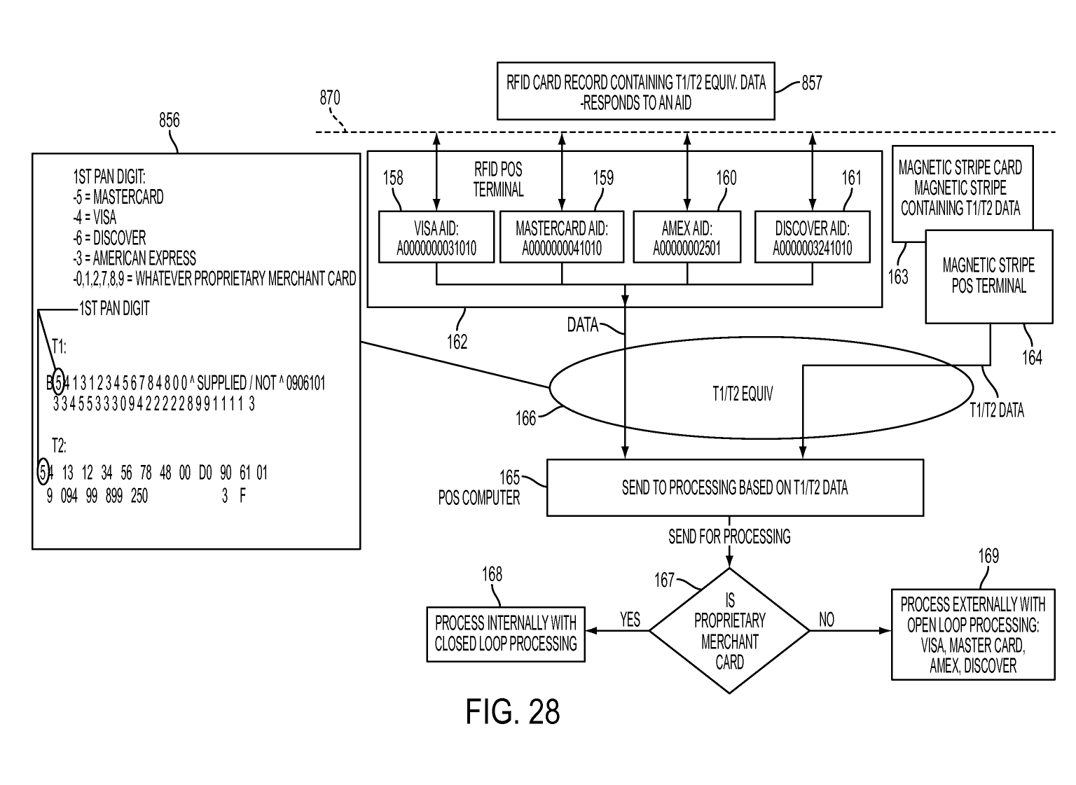

FIG. 28 illustrates how a merchant POS computer 165 is typically connected to both a RFID POS terminal 162 and a traditional magnetic strip terminal 164. The POS computer 165 is generally configured to receive ISO7813 Track 1/Track2 data 166 representations from either the RFID POS or the magnetic stripe terminal. At that point the POS computer 165 analyzes the data 166 to determine how to process it for purchase authorization. It may make a decision 167 based on the data 166 to process it as a “closed loop” or proprietary merchant card 168, or an “open loop” payment card that may be used an many different merchant locations like MASTERCARD, VISA, AMEX, and DISCOVERCARD 169. The data within the data 166 is the main factor as to how this decision is made. Many times the first digit of the PAN helps determine the type of card that is being used. PAN that starts with:
a. 5—is a MASTERCARD
b. 4—is a VISA
c. 6—is a DISCOVER
d. 3—is AMEX
e. 0,2,3,7,8,9 is proprietary

A PAN analysis 856 is depicted as an example of a way to determine what time of card is being used. Other format analysis techniques may also be used to determine type of card and how to process it.

FIG. 28 also shows two different types of cards being presented for payment. There is a traditional magnetic stripe card 163 that is swiped at the swipe terminal 164. The magnetic data are read from the card and delivered to the POS computer 165 in ISO7813 format. Similarly the RFID POS terminal 162 delivers data to the POS computer 165 in ISO7813 format. Prior to the RFID POS 162 delivery to the POS terminal 166, the RFID POS 162 does a bi-directional interaction with the RFID card 857 (or other secure element representation in an NFC-enabled mobile device) over a 13.56 Mhz radio interface 870.

The RFID POS 162 terminal is normally configured to interrogate a small subset of cards that may be in the field. For example, it may only look for cards that support 4 different applications such as:
a. MASTERCARD (AID: a0000000041010) (159)
b. VISA (AID: a0000000031010) (158)
c. AMEX (AID: a00000002501) (160)
d. DISCOVER (AID: a0000003241010) (161)

The RFID POS 162 uses AID Application Identifiers in order to determine which application is supported by the remote card 157. Most of the time, those applications are the ones listed above. It is possible, however, to deliver ANY track 2 equivalent data through at least one of these application identifiers. It is possible to deliver any track 2 equivalent data over VISA payWave AID (a0000000031010). The technical details of this are outlined in the detailed description for FIG. 23. Essentially it makes it possible to deliver merchant based closed loop Track 2 equivalent data over existing RFID POS terminal configured only to use open loop payment application AIDs.

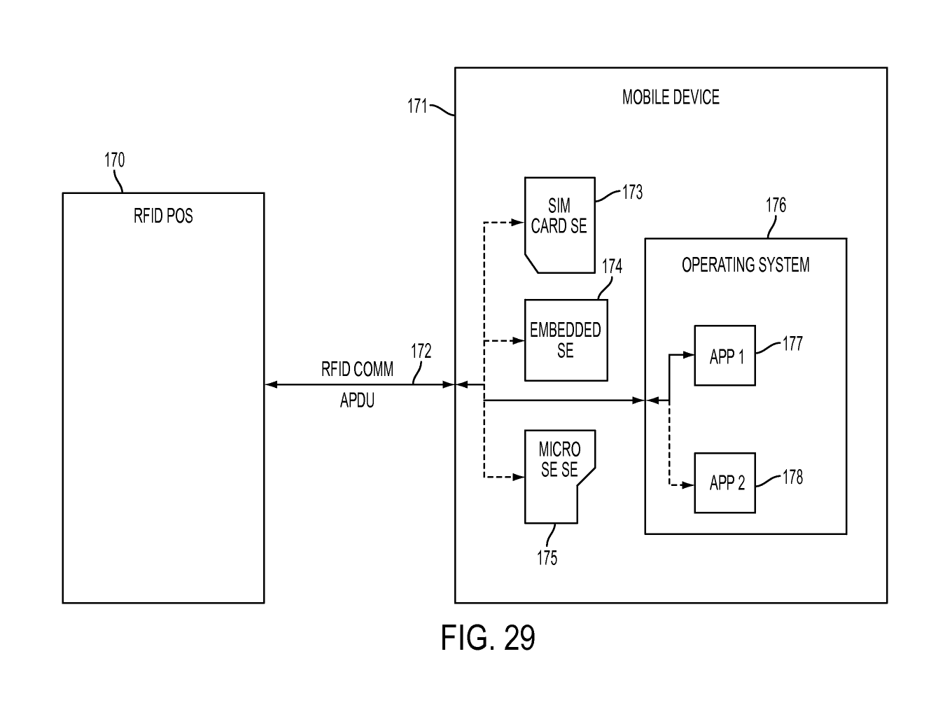

FIG. 29 illustrates how interaction with a RFID POS 170 may be accomplished completely independent of an SE within a mobile device operating system that supports independent applications. FIG. 29 illustrates the communication between the mobile device 171 and the RFID POS 170 through 13.56 MHz radio link 172 using APDU data structure. FIG. 29 also illustrates how SEs may be embedded 174 or attached to the phone 173 with a SIM card or 175 with a microSD card. The configuration depicted in FIG. 26 typically bypasses options 173, 174, and 175 in order to emulate the SE responses strictly through software emulation within the operating system 176 through an individual application 177. The OS 176 may contain multiple applications that use different aspects of the mobile device and may also control which applications are allowed to use different hardware related features of the mobile device 171. In this example, App2 178 and App1 177 both reside in the mobile device operating system 171. This example shows how the APDU data exchange is between RFID POS 170 and App1 177. The data exchange bypasses the hardware layer and enters the operating system and is directed to the particular App1 177. App1 177 contains the logic available to communicate with the RFID POS 170 and exchange transaction data over the radio link 172. FIG. 29 illustrates a system where a request from a point-of-sale terminal (i.e., a PayPass reader) may be interpreted within the operating system of the mobile device and within an application running in that operating system without the assistance of a secure element.

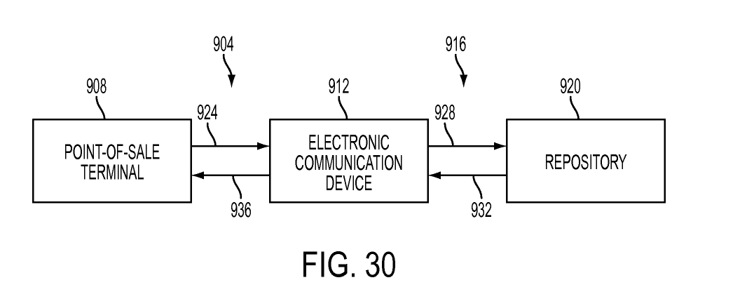

FIG. 30 illustrates communications channels and communications between a point-of-sale terminal and an electronic communication device and a repository, according to some embodiments. There is a first communication channel 904 between a point-of-sale terminal 908 and an electronic communication device 912. The first communication channel may, for example, include a near field communication channel or an internet connection. The electronic communication device 912 may be a mobile device or a stationary device. There is a second communication channel 916 between the electronic communication device 912 and a repository 920. The second communication channel 916 may include, for example, a cell-phone connection or an internet connection. A POS command communication 924 may be sent over the first communication channel 904 and a device command communication 928 may be sent over the second communication channel 916. A repository response communication 932 may be sent over the second communication channel 916 and a device response communication 936 may be sent over the first communication channel.

As disclosed herein, some embodiments disclosed herein alleviate the need for an RFID reader to be connected to a POS device and passes the function of the RFID reader to the mobile phone with NFC capabilities that is already being used in the transaction.

Some embodiments disclosed herein use the base-band processor on the NFC mobile device to do one or all of the following tasks:
a. Read the embedded secure element on the same phone just as an external RFID reader would
b. Read the embedded secure element on a separate mobile device with NFC capabilities just as an external RFID reader would
c. Read the secure element on a payment card that is presented to the mobile device just as an external RFID reader would
   Some embodiments disclosed herein combine this payment credential information with local information about the transaction and sends the information over a data connection to a designated IP address of a POS device that may send the data on to the card processor for authorization.

Some advantages of various embodiments include:
a. Merchants that would typically need to install hardware infrastructure to accept NFC payments from a mobile device may instead do so by simply adding software to a POS terminal to accept the transactional data from a data connection.
b. Payment locations that are not conducive to having power or space for an RFID reader may now accept mobile NFC payments from a mobile device
c. In addition, for many embodiments no infrastructure or processing technology changes are required for implementation.

NFC payment transactions, in particular, may be made secure by using disclosed data connection methods because the security of the transaction is based largely on the data content itself. Each transactional request that is passed through the interrogation phase of the reader and card yields Track1/Track2 equivalent data that change with every subsequent transaction, offering a single credential for each and every transaction. Further, the data content itself is shared-key-based data that may be, with virtually 100% certainty, verified that it was received from a specific card holder secure element. Because of this, the security of the data pipeline that actively transports the data are less important and may actually be considered a non-factor for the security of the financial transaction.

In some embodiments disclosed herein, provisions are made for “Reader On Device” (ROD) and “self-swiping” devices. This is referring to configurations of mobile device that contain both the SE and a reader functionality to read its own secure element. The concept of ROD may also be extended to reading other contactless cards and other SEs on other mobile devices. These configurations are not limited to one particular form factor or embodiment.

In some embodiments disclosed herein, provisions are made for acquiring a location identifier for which to determine where the mobile device should send transactional information. The location identifier may be determined through various methods such as:
a. Scanning a QR code to determine location and other transaction specific information
b. Scanning a passive RFID tag to determine location and other transaction specific information
c. Using GPS geo-location software and hardware to determine the location of a specific mobile device in order to determine a single location or limit a search to a smaller set of locations
d. User input of a location or selecting of a location from a list In some embodiments disclosed herein, provisions are made for acquiring transactional information to accompany credentials. Some transactional information may be data items such as order identifier, table identifier, transaction identifier, GPS coordinates, universal timestamp, UN (unpredictable number) data that used in the transaction processing to acquire the Track1/Track2 data. This information may be determined through various methods such as:
a. User input of data
b. QR code which contains this data or a link to this data, or portions of data that will be used
c. A passive RFID tag which contains this data or a link to this data, or portions of data that will be used
d. All of a.-c. above for all or portions of this data

In some embodiments disclosed herein, a specific payment standard issued from MASTERCARD International. This standard is based on reference documentation published by PayPass—Mag Stripe (V3.3).pdf and other derivations. In this specification, PayPass contactless payment card reader and card interrogation is documented. This document discusses specifically how an RFID reader interrogator would interact with a card containing a SE to extract and build Track1/Track2 equivalent data that is compatible for existing processing infrastructure, but contains the more secure and dynamic aspects of SE driven credential data.

In some embodiments disclosed herein, provisions are made for managing a remote system containing of a plurality of SE readers, each one being addressable and matched to a particular mobile device.

In some embodiments disclosed herein provisions are made for authenticating and validating a mobile device with a remote system to obtain access to a particular SE within a plurality of SEs in that remote system.

In some embodiments disclosed herein provisions are made for connecting a mobile device to a remote service via activating a data-pass-through mode for ISO7816-4 data commands from an POS RFID reader through a mobile device NFC interface through the mobile device OS, to a data connection to a remote system containing a plurality SEs.

In some embodiments disclosed herein provisions are made for using TCP/UDP/IP sockets to enable a communication channel between a RFID POS reader and a single SE within remote system containing a plurality of SEs.

In some embodiments disclosed herein provisions are made for authenticating over SSL to enable a TCP/UDP/IP socket communication channel between a RFID POS reader and a single SE within a remote system containing a plurality of SEs.

In some embodiments disclosed herein, a specific payment standard issued from MASTERCARD International. This standard is based on reference documentation published by PayPass—Mag Stripe (V3.3).pdf and other derivations. In this specification, PayPass contactless payment card reader and card interrogation is documented. Disclosed herein are adaptations where an RFID reader interrogator interacts with a card containing an SE to extract and build Track 1/Track2 equivalent data that is compatible for existing processing infrastructure, but that incorporates at least some of the more secure and dynamic aspects of SE driven credential data.

The concept of command/response caching is disclosed herein. A cache is a component that transparently stores data so that future requests for that data may be served faster. The data that are stored within a cache may be values that have been computed earlier or duplicates of original values that are stored elsewhere. If requested data are contained in the cache (“cache hit”), this request may be served by simply reading the local cache, which is comparatively faster that accessing the remote source. Otherwise (“cache miss”), the data have to be recomputed or fetched from its original storage location, which is comparatively slower. Hence, the more requests that may be served from the local cache, the faster will be the overall system performance.

In some embodiments disclosed herein, similar to transaction caching above, provisions are made for one hundred percent transaction caching. These are methods and configurations that allow a mobile device to request a cache from the remote authentication system, where the response encompasses a single entire transaction. This cache may be stored securely in non-persistent memory (RAM) and used only at the time of transaction with the remote RFID reader in the future.

Building on systems for local caching as described above, some embodiments may allow a mobile device and a remote RFID reader to interact exclusively with each other at the time of transaction without performing a remote request that may result in a network delay.

Various embodiments include systems and methods for interacting with a remote terminal. Just as a remote RFID interrogator or reader may interact with the mobile device, a mobile device that does not have the ability to interact with an NFC reader may be interrogated by a remote terminal using the same data protocol (7816-4) over TCP/UDP/IP. The main advantages of these embodiments are:
a. Allowing interaction with a remote SE or SE software representation that is associated with a particular device with a remote terminal
b. Tasks that a remote terminal may implement include personalization or programming of a particular SE
c. A remote terminal may also interrogate a remote SE that is associated with a mobile device is order to authenticate and/or transact with a particular application that resides on that remote SE or remote SE representation

Various embodiments are provided for transacting with a remote SE or remote SE representation in order to receive Track 1 or Track 2 equivalent data or parts of that data for use with a remote merchant website or remote merchant POS system over TCP/UCP/IP. Some advantages of these embodiments include:
a. Using card present data for authorization of a purchase from a remote merchant website
b. Using card present data for authorization of a purchase from a remote merchant POS terminal in the event the merchant POS terminal does not support NFC
c. Using card present data for authorization of a purchase from a remote merchant POS terminal in the event the mobile device does not support NFC

Various embodiments provide for the use of static or persistent magnetic stripe data and masquerading that data into a contactless transaction. Some advantages of these embodiments include resolving the problem that many existing merchant closed loop payment and open loop payment card programs do not support NFC or RFID transactions. With such embodiments a mobile device may be able to still use these types of cards to make a transaction with a POS or remote terminal or website.

Various embodiments provide a software representation of a SE. The advantages of such embodiments include replacing a concept that may commonly perceived as a hardware solution with a software solution that saves in cost as well as space requirements.

Disclosed herein are various embodiments for masquerading various types of Track Data over multiple NFC or RFID applications. Some advantages of such embodiments include:
a. Some NFC or RFID applications such as VISA payWave may not require input from the RFID POS terminal in order for it to build the Track 1 or Track 2 equivalent data. In this scenario, any Track Data value may be substituted into the format of the application in order for the end result of the Track1/Track2 data to be equivalent to an authentic magnetic stripe format for any particular application. This allows from a closed loop payment schema to be executed over the VISA payWave AID in order to be processed uniquely as such by a merchant POS.
b. Just as above, it is possible to do a transaction with a remote PayPass card and substitute the resulting Track1/Track2 information into the appropriate locations of the VISA payWave AID application in order for the resulting Track1/Track2 data to be conceived by the RFID POS terminal and passed to the merchant POS as a PayPass card.
c. In this manner a PayPass card terminal that is not local to the transaction may be used to make a transaction ahead of the actual time of transaction and passed to the merchant POS at transaction time without real time interaction with the PayPass SE. This reduces network latency.

Disclosed herein are various embodiments using an application within an operating system of a mobile device to emulate the 7816-4 data layer of an SE. Some advantages of such embodiments include:
a. Bypassing or not using SE hardware in order to make a transaction from some other form of logic on the handset
b. Some applications that interact between the POS and a credential may not require an SE as the credential storage area. In these cases, a software application may be sufficient in handing the commands from the remote RFID POS.

Some embodiments disclosed herein use a base-band processor on the NFC mobile device to do one or all of the following tasks:
a. Begin a connection to a POS RFID reader through the mobile device's NFC radio interface.
b. Receive commands through the mobile device's NFC radio interface from the interrogation sequence offered by the POS RFID reader and pass those same commands to a remote system that is configured to receive those commands.
c. Receive responses from a remote system and pass those responses to a POS RFID reader through the mobile device's NFC radio interface.

Alternatively, some embodiments use the base-band processor in the mobile device to do one or all of the following tasks:
a. Begin a TCP/UPD/IP connection to a remote merchant website or remote merchant POS system.
b. Interrogate an SE on a remote system in order to build or acquire pieces of card present data such as Track 1 and Track 2 data.
c. Deliver the Track1 and Track2 data or pieces of that data directly to the remote merchant website or remote merchant POS system.

Alternatively, some embodiments use the base-band processor in the mobile device to do one or all of the following tasks:
a. Begin a connection to a remote terminal configured to interrogate using 7816-4 data over TCP/UDP/IP.
b. Receive commands through this remote terminal interface over TCP/UDP/IP interface from the remote terminal and pass those same commands to a remote system that is configured to receive those commands.
c. Receive responses from a remote system and pass those responses to a remote terminal that is configured to receive the 7816-4 data over TCP/UDP/IP.

Some embodiments disclosed herein use a remote server network and remote array of secure elements or representations of secure elements (remote system) to do one or all of the following tasks:
a. Authenticate a particular remote mobile device or owner of a mobile device that wishes to send commands from an interrogator to a SE that is contained in this system.
b. Properly address a single SE within an array of SEs to respond appropriately to a validated remote device.
c. Properly route commands that were passed to this system to a particular SE or SE software representation within the system and properly route responses from the SE out of the system to the correct validated remote device.
d. Properly bypass a remote SE or remote SE representation and respond with static or persistent data that may represent transaction data that may be used in a contactless transaction.

Some embodiments disclosed herein combine both the tasks performed by the NFC mobile device and the remote system to allow for a complete and un-interrupted interrogation between a RFID POS reader or remote terminal and an NFC mobile device. The interrogation may be performed as set forth by payment card standards such as MASTERCARD PayPass, VISA Contactless, AMEX Express Pay, and DISCOVER Zip.

The data link or data connection and communication between the mobile device and the remote system or remote terminal stated above may be carried out over standard TCP/UDP/IP services that are currently available on mobile devices.

Some advantages of the such embodiments include:
a. In the event a mobile device that is used to conduct an NFC payment transaction with an RFID terminal is lost or stolen, the remote system may be notified and communication with the SE may be blocked until the stolen or lost device is recovered or replaced. In the event the device is replaced, new card credentials do not have to be issued again, but a communication channel with the SE may be opened back up and continued upon proper authorization. Prior to this invention, all new SE credentials or cards would have to be re-issued as the hardware that contained the SE itself would have been lost or stolen also.
b. The SE that is associated with a remote mobile device may be switched to another mobile device fast and easily and is not hardware form factor dependant. The same SE may be used with multiple mobile devices, laptop or desktop computers that have the ability to connect to this remote system that contains the SE over a data connection and authenticate properly.
c. Compared to changing hardware interfaces, and array of different hardware interfaces, and supported hardware interfaces on a mobile device, a data connection is ubiquitous and standard. SE's currently have various hardware form factors such as:
   i. Embedded microchip (soldered to a circuit board)
   ii. SD, mini-SD, micro-SD interface
   iii. USB interface
   iv. SIM card interface
   Many mobile devices support different sets of the above hardware form factors and many support none of them at all, however, most all mobile devices support a data connection. This ubiquity aids to the portability of SE applications from device to device.
d. Because some embodiments contain an array of SEs or SE representations, and because the remote system is designed to host and connect SE applications to multiple remote devices, it is possible for multiple remote devices from separate remote device owners to share a single SE from the array of SEs in the remote system. This sort of sharing of space on the SE enables consolidation and ultimately savings by more efficient utilization of memory on an array of SEs.
e. Because some embodiments do not rely on a hardware specific interface for the SE, but a data connection only. It is a more ubiquitous interface and may be used with more devices without being modified or changed from a hardware perspective.
f. Because some embodiments use an array or plurality of SEs, the ability to purchase SE chips in quantity for use in this array brings a possibility of a lower over-all cost per SE chip.

Some additional advantages of various embodiments also include:
a. Using “2 factor” authentication to protect connection to a remote SE from a mobile device. Upon authentication, a connection channel may be opened to a SE that relates to a particular mobile device. 2 factor authentication comprises of “something you have or do” AND “something you know”.
b. An example of using “something you do” and “something you know” is using gestures (moving the phone through 3d space in reasonably reproducible manner) and an accelerometer to measure these gestures on a mobile device to create a “gesture signature” in combination with a typed in pin or password to authenticate to a remote system with an array of SEs as defined in this invention.

Some additional advantages of various embodiments also include:
a. The ability to make a card present transaction with a mobile device that does not contain NFC capability
b. The ability to make a card present transaction with a merchant website or merchant POS that may not support NFC capability

Some additional advantages of various embodiments also include the ability to substitute commonly accepted Track 1/Track 2 specific format data elements with any open or closed loop data values and send that data over an arbitrary application AID at an RFID POS.

The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

What is claimed is:

1. A system for acquiring digital credential data comprising:
an electronic communication device;
a communication channel; and
a repository remote from the electronic communications device and having a plurality of secure element representations, wherein the repository is configured to:
a) receive a request for the digital credential data from the electronic communications device using the communication channel,
b) validate the computing device, wherein the electronic communication device is paired with one of the plurality of secure element representations;
c) extract at least a portion of the digital credential data from the paired secure element representation, and
d) send a repository response communication with the digital credential data to the electronic communication device over the communication channel; and
wherein the electronic communication device is configured to
a) authenticate to the repository,
b) send a request for the acquisition of at least a portion of the digital credential data to the repository as a device command communication over the communication channel, and
c) receive the repository response containing the digital credential data from the repository over the communication channel.

2. The system of claim 1 wherein the electronic communication device is a mobile device.

3. The system of claim 1 wherein the electronic communication device is a stationary device.

4. The system of claim 1 wherein the repository uses ISO7816 to extract at least a portion of the digital credential data from a paired secure element representation.

5. A method for acquiring digital credential data by a point-of-sale terminal having access to an internet from a mobile device that has access to the internet and that has a secure element and a secure element reader, the method comprising:
a) reading the secure element in the mobile device using the secure element reader in the mobile device; and
b) sending the digital credential data, acquired from reading the secure element in the mobile device, from the mobile device to the point-of-sale terminal over the internet.

6. The method of claim 5 further comprising:
acquiring in the mobile device a unique identifier of the point-of-sale terminal as an identified point-of-sale terminal; and
establishing a unique network address of the identified point-of-sale terminal, and wherein step b) comprises sending the digital credential data to the identified point-of-sale terminal over the internet.

7. The method of claim 5 further comprising:
reading a QR code into the mobile device; and
translating the QR code in the mobile device to identify an internet address of the point-of-sale terminal, and wherein step b) comprises sending the digital credential data over the internet to the internet address of the point-of-sale terminal.

8. The method of claim 5 further comprising:
reading an RFID tag code into the mobile device; and
translating the RFID tag code in the mobile device to identify an internet address of the point-of-sale terminal, and wherein step b) comprises sending the digital credential data over the internet to the internet address of the point-of-sale terminal.

9. The method of claim 5 further comprising using a GPS geo-location utility in the mobile device to define an internet address of the point-of-sale terminal, and wherein step b) comprises sending the digital credential data over the internet to the internet address of the point-of-sale terminal.

10. The method of claim 5 further comprising:
translating the digital credential data received by the point-of-sale terminal into Track Data; and
delivering the Track Data to a field in a transaction authorization system using keyboard emulation.

11. A method for acquiring digital credential data by a point-of-sale terminal comprising:
authenticating and validating a mobile device at a repository having a plurality of secure element representations wherein the mobile device is paired with one of the secure element representations in the repository;
sending through a first communication channel a POS command communication from the point-of-sale terminal to the mobile device requesting the digital credential data; and
sending through the first communication channel a device response communication from the mobile device to the point-of-sale terminal wherein the device response communication comprises at least a portion of the digital credential data.

12. The method of claim 11 further comprising:
sending through a second communication channel a device command communication from the mobile device to the repository; and
sending through the second communication channel a repository response communication from the repository to the mobile device wherein the repository response communication comprises at least a portion of the digital credential data.

13. The method of claim 11 further comprising:
caching at least a portion of the digital credential data in the mobile device,
wherein the device response communication comprises the cached portion of the digital credential data.

14. The method of claim 11 wherein the POS command communication comprises a plurality of command communications conforming to ISO7816-4 protocol, the device response communication comprises the plurality of the response communications conforming to ISO07816-4 protocol, and the method further comprises:
interpreting in the mobile device the POS command communications wherein, for at least one POS command communication the mobile device returns to the point-of-sale terminal as a portion of the device response communication a cached ISO7816-4 protocol response communication from a cache located in the mobile device.

15. The method of claim 11 further comprising:
sending through a second communication channel a device command communication from the mobile device to the repository;
and
sending through the second communication channel a repository response communication from the repository to the mobile device wherein the repository response communication comprises the at least a portion of the digital credential data.

16. The method of claim 11 wherein the repository uses ISO 7816 to extract at least a portion of the digital credential data from the paired secure element representation.

17. The method of claim 11 wherein the mobile device is proximate to the point-of-sale terminal.

18. The method of claim 11 wherein the mobile device is remote from the repository.

19. The method of claim 11 wherein the point-of-sale terminal is remote from the repository.

20. The method of claim 11 wherein the mobile device is remote from the repository and the point-of-sale terminal is remote from the repository and the digital credential data comprises Track Data.

21. The method of claim 11 wherein the first communication channel comprises a near-field communication channel.

22. The method of claim 11 wherein the first communication channel comprises a TCP/UDP/IP communication channel.

23. The method of claim 11 wherein the authenticating step comprises matching a gesture signal with a valid gesture signal.

24. The method of claim 11 wherein the POS command communication conforms to any part of ISO7816 part 1, 2, 3, or 4.

25. The method of claim 11 further comprising:
sending through a second communication channel from the mobile device to the repository a device command communication conforming to any part of ISO 7816 part 1, 2, 3, or 4; and
sending through the second communication channel a repository response communication from the repository to the mobile device wherein the repository response communication comprises the at least a portion of the digital credential data.

26. The method of claim 11 wherein the mobile device is remote from the repository and the method further comprises:
sending through a second communication channel using TCP/UDP/IP protocol from the mobile device to the repository a device command communication; and
sending through the second communication channel a repository response communication from the repository to the mobile device wherein the repository response communication comprises the at least a portion of the digital credential data.

27. The method of claim 11 wherein the mobile device is remote from the repository and the method further comprises:
sending through a second communication channel using a Secure Socket Layer and TCP/UDP/IP protocol from the mobile device to the repository a device command communication; and
sending through the second communication channel a repository response communication from the repository to the mobile device wherein the repository response communication comprises the at least a portion of the digital credential data.

28. The method of claim 11 wherein the POS command communication conforms to ISO7816-4 protocol, the device response communication conforms to ISO7816-4 protocol and the method further comprises:
sending through a second communication channel from the mobile device to the repository a device command communication that conforms to ISO7816-4 protocol; and
sending through the second communication channel a repository response communication from the repository to the mobile device a repository response communication that conforms to ISO7816-4 protocol.

29. The method of claim 11 wherein the POS command communication comprises a plurality of command communications conforming to ISO7816-4 protocol, the device response communication comprises the plurality of the response communications conforming to ISO7816-4 protocol, and the method further comprises:
sending through a second communication channel from the mobile device to the repository a plurality of device command communications conforming to ISO7816-4 protocol; and
sending through the second communication channel a repository response communication from the repository to the mobile device a plurality of response communications conforming to ISO7816-4 protocol.

30. The method of claim 11 wherein the method further comprises converting inside the mobile device at least a portion of the credential data into Track Data.

31. The method of claim 11 wherein the mobile device is remote from the point-of-sale terminal, and wherein the method further comprises:
converting inside the mobile device at least a portion of the credential data into Track Data; and
providing the Track Data formatted as digital credential data according to ISO7813 as at least a portion of the device response communication.

32. The method of claim 11 wherein the mobile device is remote from the repository, the point-of-sale terminal is remote from the repository, the repository comprises a database of static Track Data, and the method further comprises:
constructing in the repository cache data or at least a portion of a repository response communication using the database of static Track Data.

33. The method of claim 11 wherein:
the first communication channel comprises an NFC communication channel;
the POS command communication comprises a select file command conforming to ISO7816-4 protocol using a VISA AID starting with A000000003; and
the device response communication comprises digital credential data that does not have a beginning PAN digit, as defined in ISO7813, equal to a numeral “4”.

34. The method of claim 11 wherein:
the first communication channel comprises an NFC communication channel;
the POS command communication comprises a select file command conforming to ISO7816-4 protocol using a VISA AID starting with A000000003;
the device response communication comprises digital credential data that does not have a beginning PAN digit, as defined in ISO7813, equal to a numeral “4”; and
the method further comprises formatting the digital credential data in the point-of-sale terminal into a digital credential that is identical to a static magnetic stripe card that conforms to ISO7813.

35. A system for acquiring digital credential data using a mobile device comprising:
a point-of-sale terminal having a NFC interface using ISO7816-4 protocol to transmit a request for the digital credential data and to receive digital credential data; and
a mobile device having a NFC interface using ISO7816-4 protocol configured to
a) receive the request from the point-of-sale terminal for an acquisition of the digital credential data,
b) interpret the request from the point-of-sale within an operating system of the mobile device and within an application running in that operating system, and
c) send the digital credential data to the point-of-sale terminal using ISO8916-4 protocol generated from an application running in an operating system in the mobile device.

36. A system for acquiring digital credential data comprising:
a mobile device;
a first communication channel;
a point-of-sale terminal configured to generate a request for an acquisition of the digital credential data from the mobile device over the first communication channel as a POS command communication, and configured for receiving the digital credential data from the mobile device over the first communication channel as a device response communication; and
a repository that is remote from the point-of-sale terminal, the repository having a plurality of secure element representations and being configured to validate the mobile device and pair the mobile device with a specific secure element representation; and
wherein the mobile device is remote from the repository and is configured to
a) authenticate to the repository;
b) receive the POS command communication over the first communication channel, and
c) send at least a portion of the digital credential data to the point-of-sale terminal as the device response communication over the first communication channel.

37. The system of claim 36 further comprising a second communication channel and wherein:
the repository is configured to receive a request for the digital credential data from the mobile device using the second communication channel and to send a response with at least a portion of the digital credential data to the mobile device using the second communication channel.

38. The system of claim 36 wherein the mobile device comprises a cache memory configured to store at least a portion of the digital credential data as cached data and the mobile device is configured to send the cached data as at least a portion of the device response communication.

39. The system of claim 36 wherein the repository uses ISO7816 to extract the at least a portion of the digital credential data from the paired secure element representation.

40. The system of claim 36 wherein the mobile device is proximate to the point-of-sale terminal.

41. The system of claim 36 wherein the mobile device is remote from the repository.

42. The system of claim 36 wherein the point-of-sale terminal is remote from the repository.

43. The system of claim 36 wherein the mobile device is remote from the repository and the point-of-sale terminal is remote from the repository and the digital credential data comprises Track Data.

44. The system of claim 36 wherein first communication channel comprises a near-field communication channel.

45. The system of claim 36 wherein the mobile device is remote from the point-of-sale terminal and the first communication channel comprises a TCP/UDP/IP communication channel.

46. The system of claim 36 wherein the mobile device is configured for generating a gesture signal and to authenticate to the repository by matching the gesture signal with a valid gesture signal.

47. The system of claim 36 wherein the repository comprises a digital database of a plurality of mobile device identifications and at least one secure element representation identifier associated with each mobile device and the repository is configured to validate the mobile device using the digital database.

48. The system of claim 36 wherein the mobile device comprises non-persistent memory for caching a cached portion of the digital credential data and the mobile device is configured to provide the cached portion to the point-of-sale terminal through the first communication channel.

49. The system of claim 36 wherein there is a plurality of command communications and a plurality of response communications over the first communication channel.

50. The system of claim 36 wherein the request for the acquisition of the digital credential data and the device response communication comprise 7816-4 data.

51. The system of claim 36 further comprising a second communication channel and wherein:
the repository is configured to receive a request for the digital credential data from the mobile device using the second communication channel and to send a response with at least a portion of the digital credential data to the mobile device using the second communication channel; and
wherein the device command communication and the repository response communication comprise 7816-4 data.

52. The system of claim 36 further comprising a second communication channel and wherein:
the repository is configured to receive a request for the digital credential data from the mobile device using the second communication channel and to send a response with at least a portion of the digital credential data to the mobile device using the second communication channel; and
wherein the first communication channel and the second communication channel comprise TCP/UDP/IP communication channels.

53. A repository for secure element representations comprising:
at least one secure element reader;
a plurality of secure element representations disposed proximate to the secure element reader;
a server disposed proximate to the secure element reader, the server having a multitasking processor to communicate with the plurality of secure element representations through the secure element reader and conduct a plurality of command/response time-wise overlapping sessions with the plurality of secure element representations; and
an internet connection to the server wherein each of the secure element representations is addressable over the internet.

54. The repository of claim 53 wherein the plurality of secure element representations is selected from the group consisting of hardware representations, virtual hardware representations, and a combination thereof.

55. A method for acquiring digital credential data by a point-of-sale terminal comprising:
authenticating and validating a stationary device at a repository having a plurality of secure element representations wherein the stationary device is paired with one of the secure element representations in the repository;
sending through a first communication channel a POS command communication from the point-of-sale terminal to the stationary device requesting the digital credential data; and
sending through the first communication channel a device response communication from the stationary device to the point-of-sale terminal wherein the device response communication comprises the digital credential data.

56. The method of claim 55 further comprising a second communication channel and wherein:
the repository is configured to receive a request for the digital credential data from the stationary device using the second communication channel and to send a response with at least a portion of the digital credential data to the stationary device using the second communication channel.
